(19) United States
(12) Patent Application Publication
(10) Pub. No.: US 2021/0368373 A1
(43) Pub. Date: Nov. 25, 2021

(54) MA PDU SESSION METHOD AND DEVICE

(71) Applicant: LG Electronics Inc., Seoul (KR)

(72) Inventors: Myungjune YOUN, Seoul (KR); Hyunsook KIM, Seoul (KR); Laeyoung KIM, Seoul (KR)

(21) Appl. No.: 17/041,141

(22) PCT Filed: Feb. 6, 2020
(86) PCT No.: PCT/KR2020/001697

§ 371 Date: Sep. 24, 2020

(30) Foreign Application Priority Data
Feb. 14, 2019 (KR) 10-2019-0017063
Jun. 18, 2019 (KR) 10-2019-0072476
Jun. 20, 2019 (KR) 10-2019-0073699
Jan. 6, 2020 (KR) 10-2020-0001454

(51) Int. Cl. H04W 24/10; H04W 28/10

(52) U.S. Cl. CPC H04W 24/10; H04W 80/10; H04W 28/10

(57) ABSTRACT

One disclosure of the present specification provides a method for a multi access (MA) protocol (PDU) session by a device. The method may comprise a step of receiving measurement assistance information from a Session Management Function (SMF) node. The measurement assistance information may be related to the MA PDU session on 3rd generation partnership project (3GPP) access and non-3GPP access. The method may comprise a step of transmitting a report on the basis of the measurement assistance information. The report may include information on availability or non-availability of any one of the 3GPP access or the non-3GPP access. The report may be transmitted to a User Plane Function (UPF) node by means of a user plane.

### BACKGROUND OF THE DISCLOSURE

### Field of the Disclosure

The present disclosure relates to a mobile communication.

### Related Art

With the success of long term evolution (LTE)/LTE-A (LTE-Advanced) for the 4th generation mobile communication, more interest is rising to the next generation, i.e., 5th generation (also known as 5G) mobile communication and extensive research and development are being carried out accordingly.

The 5G mobile communication defined in the international telecommunication union (ITU) provides a data transfer rate of up to 20 Gbps and a sensible transfer rate of at least 100 Mbps anytime anywhere. ‘IMT-2020’ is a formal name, and aims to be commercialized in the year 2020 worldwide.

The 5G mobile communication supports a plurality of numerologies or subcarrier spacing (SCS) for supporting various services. For example, when the SCS is 15 kHz, a wide area over conventional cellular bands is supported; in the case of 30 kHz/60 kHz, a dense urban area, lower latency, and wider carrier bandwidth is supported; and when the SCS is larger than 60 kHz or higher, bandwidth larger than 24.25 GHz is supported to overcome phase noise.

The NR frequency band is defined by two types (FR1, FR2) of frequency ranges. The FR1 ranges from 410 MHz to 7125 MHz, and the FR2 ranges from 24250 MHz to 52600 MHz, which may correspond to the millimeter wave (mmW) range.

For the convenience of descriptions, in the frequency range used for the NR system, the FR1 may indicate the “sub-6 GHz range” while the FR2 may indicate the “above 6 GHz range” and may be referred to as the millimeter wave (mmW).

TABLE 1

| Frequency Range | Corresponding | |
|---|---|---|
| designation | frequency range | Subcarrier Spacing |
| FR1 | 450 MHz-6000 MHz | 15, 30, 60 kHz |
| FR2 | 24250 MHz-52600 MHz | 60, 120, 240 kHz |

As described above, the numerical values of the frequency ranges in the NR system may be changed. For example, the FR1 may include a frequency band ranging from 410 MHz to 7125 MHz as shown in Table 2. In other words, the FR1 may include a frequency band higher than 6 GHz (or 5850, 5900, or 5925 MHz). For example, a frequency band higher than 6 GHz (or 5850, 5900, or 5925 MHz) included in the FR1 may include the unlicensed band. The unlicensed band may be utilized for various applications, which may include communication for vehicles (for example, autonomous driving).

TABLE 2

| Frequency Range | Corresponding | |
|---|---|---|
| designation | frequency range | Subcarrier Spacing |
| FR1 | 410 MHz-7125 MHz | 15, 30, 60 kHz |
| FR2 | 24250 MHz-52600 MHz | 60, 120, 240 kHz |

The ITU proposes three usage scenarios, e.g., eMBB(enhanced Mobile BroadBand), mMTC(massive Machine Type Communication), and URLLC(Ultra Reliable and Low Latency Communications).

First, the URLLC relates to a usage scenario which requires a high reliability and a low latency. For example, a service such as autonomous driving, factory automation, and augmented reality requires a high reliability and a low latency (e.g., a latency less than or equal to 1 ms). At present, a latency of 4G (LTE) is statistically 21-43 ms (best 10%), 33-75 ms (median). This is insufficient to support a service requiring the latency less than or equal to 1 ms.

Next, an eMBB usage scenario relates to a usage scenario requiring a mobile ultra-wide band.

It seems that a core network designed for the existing LTE/LTE-A has difficulty in accommodating a high-speed service of the ultra-wide band.

Therefore, it is urgently required to re-design the core network in 5G mobile communication.

FIG. 1 illustrates a structure of the next-generation mobile communication network.

The 5G Core (5GC) may include various constituting elements, and FIG. 1 shows Access and Mobility Management Function (AMF) 41, Session Management Function (SMF) 42, Policy Control Function (PCF) 43, User Plane Function (UPF) 44, Application Function (AF) 45, Unified Data Management (UDM) 46, and Non-3GPP InterWorking Function (N3IWF) 49, which correspond to part of the constituting elements.

The UE 10 is connected to the data network via the UPF 44 through the Next Generation Radio Access Network (NG-RAN).

The UE 10 may receive a data service even through untrusted non-3rd Generation Partnership Project (3GPP) access, for example, Wireless Local Area Network (WLAN). To connect the non-3GPP access to the core network, the N3IWF 49 may be deployed.

FIG. 2 shows an example of an expected structure of next-generation mobile communication from a node perspective.

As can be seen with reference to FIG. 2, a UE is coupled to a data network (DN) via a next generation radio access network (RAN).

The illustrated control plane function (CPF) node performs the entirety or part of a mobility management entity (MME) function of 4G mobile communication and the entirety or part of a control plane function of an S-serving gateway (SG) and PDN gateway (P-GW). The CPF node includes an access and mobility management function (AMF) and a session management function (SMF).

The illustrated user plane function (UPF) node is a type of a gateway through which user data is transmitted/received. The UPF node may perform the entirety or part of a user plane function of an S-GW or P-GW of 4G mobile communication.

The illustrated policy control function (PCF) is a node which controls a provider's policy.

The illustrated application function (AF) is a server for providing several services to the UE.

The illustrated unified data management (UDM) is a type of a server which manages subscriber information, such as a home subscriber server (HSS) of 4G mobile communication. The UDM stores the subscriber information in a unified data repository (UDR) and manages it.

The illustrated authentication server function (AUSF) authenticates and manages the UE.

The illustrated network slice selection function (NSSF) is a node for network slicing as described below.

In FIG. 2, the UE can simultaneously access two data networks by using multiple protocol data unit or packet data unit (PDU) sessions.

FIG. 3 shows an example of an architecture for supporting simultaneous access to two data networks.

In the architecture shown in FIG. 3, a UE uses one PDU session to simultaneously access the two data networks.

Reference points shown in FIGS. 2 and 3 are as follows.

N1 represents a reference point between the UE and the AMF.

N2 represents a reference point between the (R)AN and the AMF.

N3 represents a reference point between the (R)AN and the AMF.

N4 represents a reference point between the SMF and the UPF.

N5 represents a reference point between the PCF and the AF.

N6 represents a reference point between the UPF and the DN.

N7 represents a reference point between the SMF and the PCF.

N8 represents a reference point between the UDM and the AMF.

N9 represents a reference point between the UPFs.

N10 represents a reference point between the UDM and the SMF.

N11 represents a reference point between the AMF and the SMF.

N12 represents a reference point between the AMF and the AUSF.

N13 represents a reference point between the UDM and the AUSF.

N14 represents a reference point between the AMFs.

N15 represents a reference point between the PCF and the AMF.

N16 represents a reference point between the SMFs.

N22 represents a reference point between the AMF and the NSSF.

FIG. 4 illustrates another example of a structure of a radio interface protocol between a UE and a gNB.

The radio interface protocol is based on the 3GPP radio access network specification. The radio interface protocol horizontally includes a physical layer, a data link layer, and a network layer; and is divided vertically into a user plane for data information transfer and a control plane for signaling transfer.

The protocol layers may be divided into a first layer (L1), a second layer (L2), and a third layer (L3) based upon the lower three layers of the Open System Interconnection (OSI) reference model widely used for communication systems.

In what follows, each layer of the radio interface protocol will be described.

The physical layer, namely the first layer, provides an information transfer service by using a physical channel. The physical layer is connected to a Medium Access Control (MAC) layer, namely, an upper layer of the physical layer, via a transport channel. Data is transferred between the MAC layer and the physical layer through the transport channel. In addition, data is transferred between different physical layers, namely, between physical layers of a transmitting side and a receiving side, through the physical channel.

The second layer includes the MAC layer, a Radio Link Control (RLC) layer, and a Packet Data Convergence Protocol (PDCP) layer.

The third layer include a Radio Resource Control (hereinafter, simply referred to as RRC). The RRC layer is defined only in the control plane and serves to control the logical channel, the transport channel, and the physical channel in association with configuration, re-configuration, and release of radio bearers (hereinafter, RBs for short). In this case, the RB represents a service provided by the second layer for data transfer between the UE and the E-UTRAN.

The Non-Access Stratum (NAS) layer performs a function such as connection management (session management) and mobility management.

The NAS layer is divided into a NAS entity for Mobility Management (MM) and a NAS entity for Session Management (SM).

1) The NAS entity for MM provides the following typical function.

The following are included as a NAS procedure related to the AMF.
Registration management and access management procedure: The AMF supports the following function.
Reliable NAS signal connectivity (integrity protection, encryption) between the UE and the AMF

2) The NAS entity for SM performs session management between the UE and the SMF.

An SM signaling message is processed, namely, generated and processed, in a NAS-SM layer of the UE and the SMF. Content of the SM signaling message is not interpreted by the AMF.
In the case of SM signaling transmission,
The NAS entity for MM generates a NAS-MM message to induce a location and method for transferring an SM signaling message through a security header indicating NAS transmission of SM signaling and additional information for NAS-MM to be received.
In the case of receiving SM signaling, the NAS entity for SM performs integrity checking of the NAS-MM message and interprets additional information to induce a place and a method for deriving an SM signaling message.

Meanwhile, in FIG. 4, an RRC layer, and RLC layer, a MAC layer, and a PHY layer located below the NAS layer are collectively called an access stratum (AS) layer.

A network system (namely 5GC) for the next generation mobile communication (namely 5G) also supports non-3GPP access. Atypical example of the non-3GPP access is WLAN access. The WLAN access may include both trusted and untrusted WLANs.

In the 5G system, the AMF performs not only 3GPP access but also Registration Management (RM) and Connection Management (CM) for non-3GPP access.

A Multi-Access (MA) PDU session which uses both the 3GPP access and the non-3GPP access may be used.

The MA PDU session may be generated by bundling two individual PDU sessions established on two accesses.

However, there is a problem that a network node, for example, the SMF is unable to know exactly whether specific access to which an MA-PDU session is connected becomes available or unavailable.

### SUMMARY OF THE DISCLOSURE

Therefore, the present disclosure is intended to provide a method that may solve the aforementioned problem.

Accordingly, in an effort to solve the aforementioned problem, a disclosure of the present disclosure provides a method for multi-access (MA) protocol data unit (PDU) session. The method may be performed by a user equipment (UE) and comprise: receiving measurement assistance information from a session management function (SMF) node. The measurement assistance information may relate to the MA PDU session over a 3rd generation partnership project (3GPP) access and non-3GPP access. The method may comprise: transmitting a report, based on the measurement assistance information. The report may include information on an availability or unavailability of at least one access of the 3GPP access and the non-3GPP access. The report may be transmitted via a user plane to a user plane function (UPF) node.

To solve the aforementioned problem, one aspect of the present disclosure also provides a method for a Multi-Access (MA) Protocol Data Unit (PDU) session by a Session Management Function (SMF) node. The method may include transmitting measurement assistance information to a User Equipment (UE). The measurement assistance information may be related to the MA PDU session over 3rd Generation Partnership Project (3GPP) access and non-3GPP access. The method may include receiving a report on the UE from a User Plane Function (UPF) node. The report may include information on availability or unavailability of at least one access of the 3GPP access and the non-3GPP access in the MA PDU session. The method may include performing traffic steering for the MA PDU session based on the received report.

To solve the aforementioned problem, one aspect of the present disclosure provides a method for a Multi-Access (MA) Protocol Data Unit (PDU) session. The method may be performed by a Session Management Function (SMF) node. The method may comprise, transmitting a first message for requesting a reactivating a user plane resource over at least one access of a 3rd generation partnership project (3GPP) access and non-3GPP access, based on that the user plane resource over the at least one access is in an inactive state; receiving a second message from an Access and Mobility Management Function (AMF) node; and transmitting a third message including information that the UE is unreachable over the at least one access, based on that the second message is used to notify that the UE is unreachable over the at least one access.

To solve the aforementioned problem, one aspect of the present disclosure provides a method for a Multi-Access (MA) Protocol Data Unit (PDU) session by a User Plane Function (UPF) node. The method may comprise, when there exists downlink data to be transmitted to a UE through first access between 3rd Generation Partnership Project (3GPP) access and non-3GPP access to which an MA PDU session has been established, transmitting packet data for checking availability of the first access; when a response to the packet data is received from the UE, transmitting the downlink data to the UE through the first access; and when a response to the packet data is not received from the UE, transmitting the downlink data to the UE through second access.

To solve the aforementioned problem, one aspect of the present disclosure provides an apparatus for a Multi-Access (MA) Protocol Data Unit (PDU) session. The apparatus may comprise at least one processor; and at least one memory capable of storing instructions and being connected electrically to the at least one processor operably. An operation, performed when the instructions are executed by the at least one processor, may include receiving measurement assistance information from a Session Management Function (SMF) node. The measurement assistance information may be related to the MA PDU session over 3rd Generation Partnership Project (3GPP) access and non-3GPP access. The operation may include transmitting a report, based on the measurement support information. The report may include information on availability or unavailability of at least one of the 3GPP access and the non-3GPP access. The report may be transmitted via a user plane to a User Plane Function (UPF) node.

To solve the aforementioned problem, one aspect of the present disclosure provides a non-volatile computer-readable storage medium recording instructions. The instructions, when executed by one or more processors, may instruct the one or more processors to perform receiving measurement assistance information from a Session Management Function (SMF) node. The measurement assistance information may be related to the MA PDU session on 3rd Generation Partnership Project (3GPP) access and non-3GPP access. The instructions, when executed by one or more processors, may instruct the one or more processors to perform transmitting a report, based on the measurement report information. The report may include information on availability or unavailability of at least one of the 3GPP access and the non-3GPP access. The report may be transmitted via a user plane to a User Plane Function (UPF) node.

To solve the aforementioned problem, one aspect of the present disclosure provides a Session Management Function (SMF) node for a Multi-Access (MA) Protocol Data Unit (PDU) session. The SMF node may comprise at least one processor; and at least one memory capable of storing instructions and being connected electrically to the at least one processor operably. An operation, performed when the instructions are executed by the at least one processor, may include transmitting measurement assistance information to a UE. The measurement assistance information may be related to the MA PDU session over 3rd Generation Partnership Project (3GPP) access and non-3GPP access. The operation may include receiving a report on the UE from a User Plane Function (UPF) node. The report may include information on availability or unavailability of at least one of the 3GPP access and the non-3GPP access within the MA PDU session. The operation may include performing traffic steering for the MA PDU session based on the received report.

To solve the aforementioned problem, one aspect of the present disclosure provides a Session Management Function (SMF) node for a Multi-Access (MA) Protocol Data Unit (PDU) session. The SMF node may comprise at least one processor; and at least one memory capable of storing instructions and being connected electrically to the at least one processor operably. An operation, performed when the instructions are executed by the at least one processor, may include, transmitting a first message for requesting a reactivating a user plane resource over at least one access of a 3rd generation partnership project (3GPP) access and non-3GPP access, based on that the user plane resource over the at least one access is in an inactive state; receiving a second message from an Access and Mobility Management Function (AMF) node; and transmitting a third message including information that the UE is unreachable over the at least one access, based on that the second message is used to notify that the UE is unreachable over the at least one access.

To solve the aforementioned problem, one aspect of the present disclosure provides a User Plane Function (UPF) node for a Multi-Access (MA) Protocol Data Unit (PDU) session. The UPF node may comprise at least one processor; and at least one memory capable of storing instructions and being connected electrically to the at least one processor operably. An operation, performed when the instructions are executed by the at least one processor, may include, when there exists downlink data to be transmitted to a UE through first access between 3rd Generation Partnership Project (3GPP) access and non-3GPP access to which an MA PDU session has been established, transmitting packet data for checking availability of the first access; when a response to the packet data is received from the UE, transmitting the downlink data to the UE through the first access; and when a response to the packet data is not received from the UE, transmitting the downlink data to the UE through second access.

According to the disclosure of the present disclosure, the problem of the conventional technology described above may be solved.

### BRIEF DESCRIPTION OF THE DRAWINGS

FIG. 1 illustrates a structure of the next generation mobile communication network.

FIG. 2 illustrates an expected structure of the next generation mobile communication from the perspective of a node.

FIG. 3 illustrates an architecture for supporting simultaneous accesses to two data networks.

FIG. 4 illustrates a structure of a radio interface protocol between a UE and a gNB.

FIGS. 5a and 5b are signal flows of an exemplary registration procedure.

FIGS. 6a and 6b are signal flows of an exemplary PDU session establishment procedure.

FIG. 7a illustrates an architecture to which a local breakout (LBO) scheme is applied during roaming, and FIG. 7b illustrates an architecture to which a home routed (HR) scheme is applied during roaming.

FIGS. 8a to 8f are architectures for routing data via non-3GPP access.

FIG. 9 illustrates an example of generating an MA PDU session.

FIG. 10 illustrates an example of applying an ATSSS rule to an MA PDU session.

FIGS. 11a and 11b are signal flows of a PDU session establishment procedure.

FIG. 12 illustrates a procedure for an UPF to report an availability state to an SMF.

FIGS. 13a and 13b illustrate a procedure for modifying a PDU session.

FIG. 14 summarizes disclosures of the present disclosure.

FIG. 15 illustrates a block diagram of a processor in which the present disclosure is implemented.

FIG. 16 illustrates a wireless communication system according to one embodiment.

FIG. 17 illustrates a block diagram of a network node according to one embodiment.

FIG. 18 illustrates a block diagram of a UE according to one embodiment.

FIG. 19 illustrates one example of a 5G use case scenario.

FIG. 20 illustrates an AI system according to one embodiment.

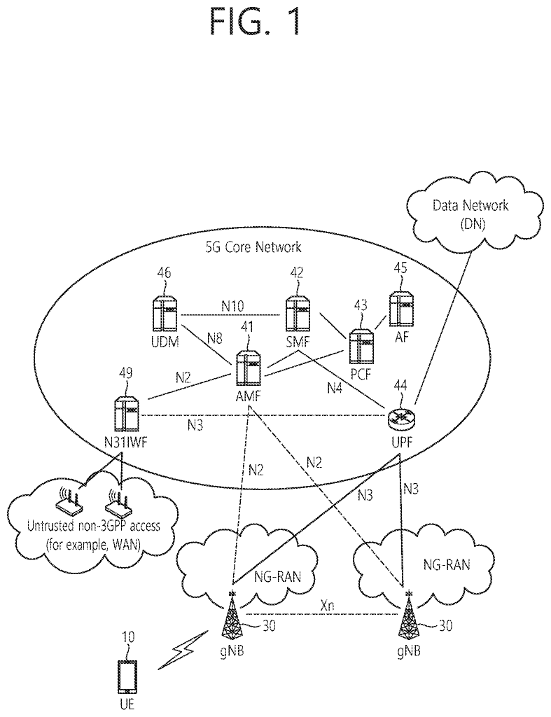

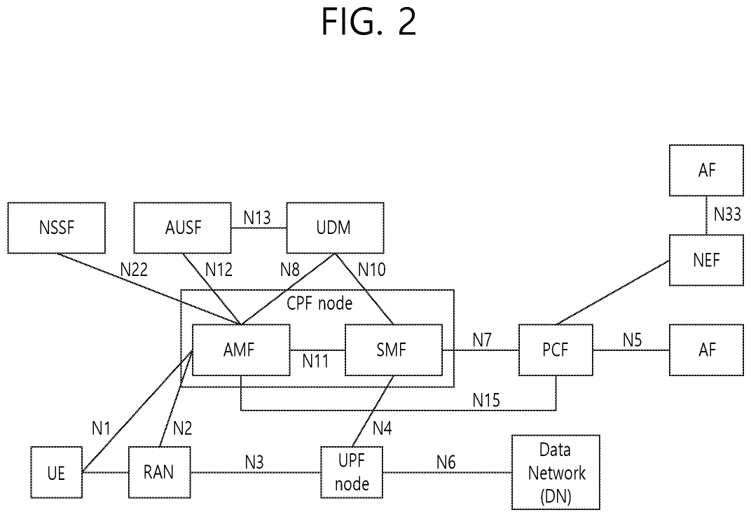

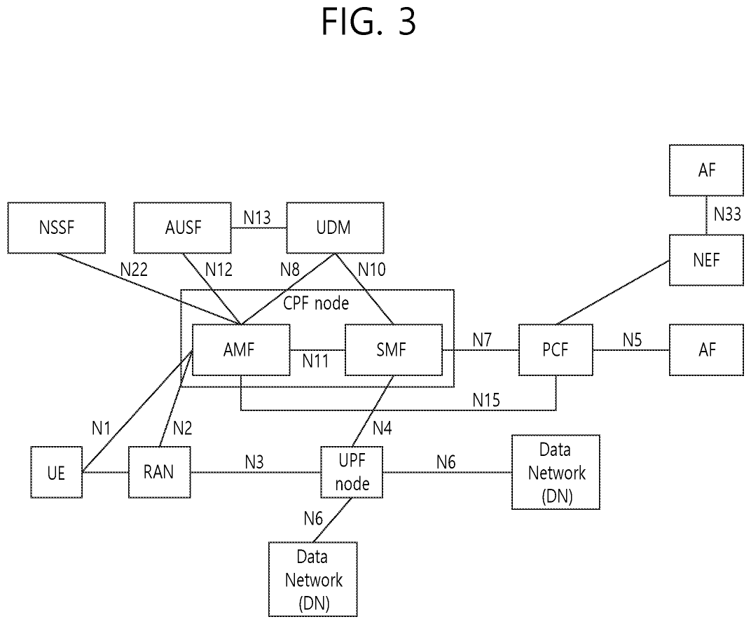

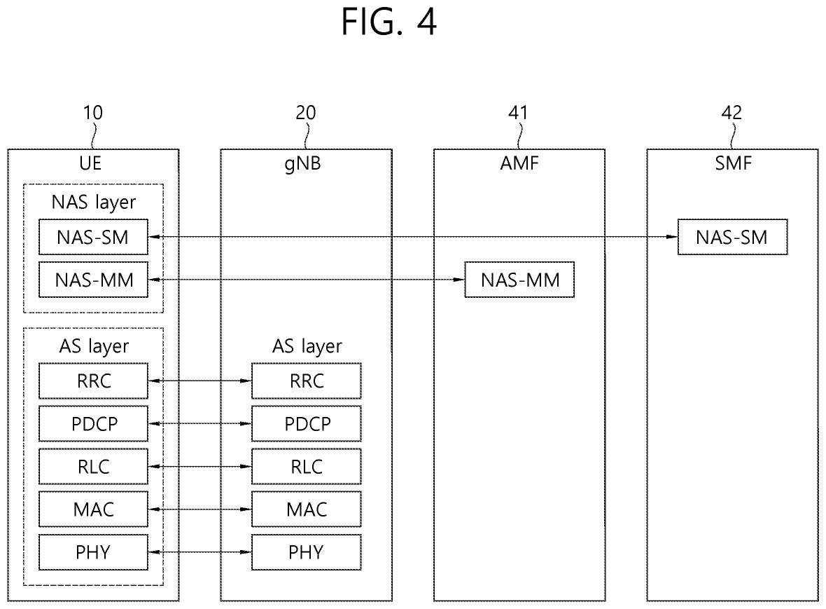

### DESCRIPTION OF EXEMPLARY EMBODIMENTS

The technical terms used herein are used to merely describe specific embodiments and should not be construed as limiting the present disclosure. Further, the technical terms used herein should be, unless defined otherwise, interpreted as having meanings generally understood by those skilled in the art but not too broadly or too narrowly. Further, the technical terms used herein, which are determined not to exactly represent the spirit of the disclosure, should be replaced by or understood by such technical terms as being able to be exactly understood by those skilled in the art. Further, the general terms used herein should be interpreted in the context as defined in the dictionary, but not in an excessively narrowed manner.

The expression of the singular number in the specification includes the meaning of the plural number unless the meaning of the singular number is definitely different from that of the plural number in the context. In the following description, the term ‘include’ or ‘have’ may represent the existence of a feature, a number, a step, an operation, a component, a part or the combination thereof described in the specification, and may not exclude the existence or addition of another feature, another number, another step, another operation, another component, another part or the combination thereof.

The terms ‘first’ and ‘second’ are used for the purpose of explanation about various components, and the components are not limited to the terms ‘first’ and ‘second’. The terms ‘first’ and ‘second’ are only used to distinguish one component from another component. For example, a first component may be named as a second component without deviating from the scope of the present disclosure.

It will be understood that when an element or layer is referred to as being “connected to” or “coupled to” another element or layer, it can be directly connected or coupled to the other element or layer or intervening elements or layers may be present. In contrast, when an element is referred to as being “directly connected to” or “directly coupled to” another element or layer, there are no intervening elements or layers present.

Hereinafter, exemplary embodiments of the present disclosure will be described in greater detail with reference to the accompanying drawings. In describing the present disclosure, for ease of understanding, the same reference numerals are used to denote the same components throughout the drawings, and repetitive description on the same components will be omitted. Detailed description on well-known arts which are determined to make the gist of the disclosure unclear will be omitted. The accompanying drawings are provided to merely make the spirit of the disclosure readily understood, but not should be intended to be limiting of the disclosure. It should be understood that the spirit of the disclosure may be expanded to its modifications, replacements or equivalents in addition to what is shown in the drawings.

The expression “A or B” as used in the present disclosure may mean “only A”, “only B” or “both A and B”. In other words, “A or B” may be interpreted as “A and/or B” in the present disclosure. For example, in the present disclosure, “A, B or C” may mean “only A”, “only B”, “only C” or “any combination of A, B and C”.

A slash (/) or a comma used in the present disclosure may mean “and/or”. For example, “A/B” may mean “A and/or B”. Accordingly, “A/B” may mean “only A”, “only B”, or “both A and B”. For example, “A, B, C” may mean “A, B or C”.

The phrase “at least one of A and B” as used in the present disclosure may mean “only A”, “only B”, or “both A and B”. Also, the expression “at least one of A or B” or “at least one of A and/or B” may be interpreted to be the same as “at least one of A and B”.

Also, the phrase “at least one of A, B and C” as used in the present disclosure may mean “only A”, “only B”, or “any combination of A, B and C”. Also, the phrase “at least one of A, B or C” or “at least one of A, B and/or C” may mean “at least one of A, B and C”.

Also, parentheses used in the present disclosure may mean “for example”. More specifically, a phrase is written as “control information (PDCCH)”, it may mean that “PDCCH” is proposed as one example of “control information”. In other words, “control information” of the present disclosure is not limited to “PDCCH”, but it may be interpreted that “PDCCH” is proposed as one example of “control information”. Also, when a phrase is written as “control information (namely, PDCCH)”, it may be interpreted that “PDCCH” is proposed as one example of “control information”.

Technical features described individually in one figure of the present disclosure may be implemented separately or simultaneously.

In the drawings, user equipments (UEs) are shown for example. The UE may also be denoted a terminal or mobile equipment (ME). The UE may be a laptop computer, a mobile phone, a PDA, a smartphone, a multimedia device, or other portable device, or may be a stationary device such as a PC or a car mounted device.

<Registration Procedure>

In order to enable mobility tracking and data reception, and receive a service, a UE may need to be authorized. To this end, the UE needs to be registered in a network. The registration procedure is performed when the UE needs to perform initial registration with respect to a 5G system. In addition, the registration procedure is performed when the UE performs periodic registration update, when the UE moves to a new tracking area (TA) in an idle mode, and when the UE needs to perform periodic registration update.

During the initial registration procedure, ID of the UE may be obtained from the UE. The AMF may transmit PEI (IMEISV) to the UDM, the SMF, and the PCF.

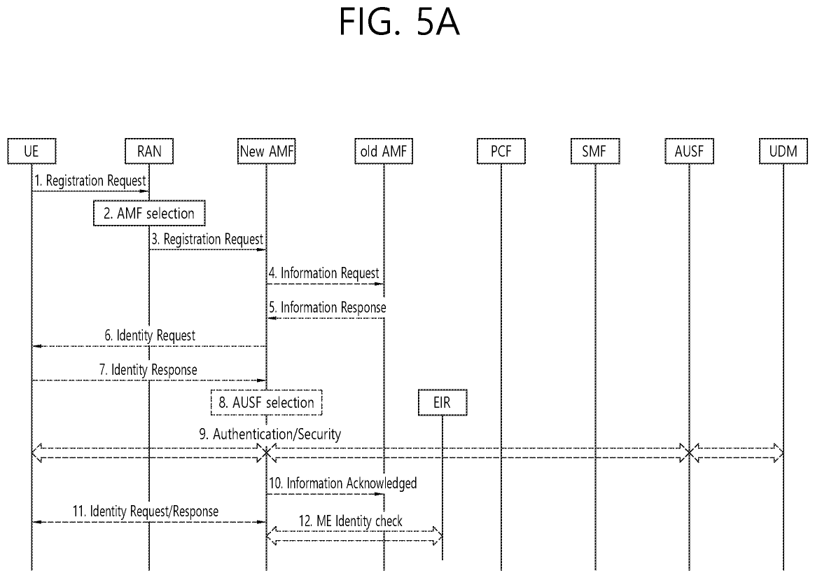

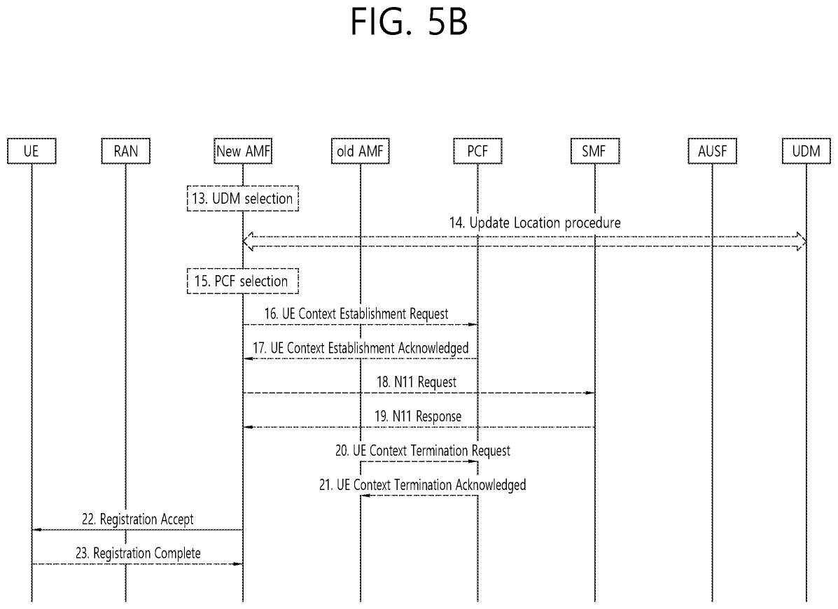

FIGS. 5a and 5b are signal flows of an exemplary registration procedure.

1) The UE may transmit an AN message to the RAN. The AN message may include an AN parameter and a registration request message. The registration request message may include information such as a registration type, a subscription permanent ID or a temporary user ID, a security parameter, Network Slice Selection Assistance Information (NSSAI), 5G capability of the UE, and a Protocol Data Unit (PDU) session state.

In the case of 5G RAN, the AN parameter may include a Subscription Permanent Identifier (SUPI) or a temporary user ID, a selected network, and NSSAI.

The registration type may indicate which state the UE is currently in among “initial registration” (namely, the UE is in a non-registered state), “mobility registration update” (namely, the UE is in a registered state and starts a registration procedure due to expiration of a periodic update timer), or “periodic registration update” (namely, the UE is in a registered state and starts a registration procedure due to expiration of a periodic update timer). If a temporary user ID is included, the temporary user ID represents the last serving AMF. If the UE has already been registered via non-3GPP access in a PLMN different from the PLMN of the 3GPP access, a temporary ID for the UE assigned by the AMF may not be provided while the UE performs the registration procedure via non-3GPP access.

The security parameter may be used for authentication and integrity protection.

The PDU session state may indicate a (previously established) PDU session available for the UE.

2) When SUPI is included or the temporary user ID does not indicate a valid AMF, the RAN may select an AMF based on (R)AT and NSSAI.

When the (R)AN is unable to select an appropriate AMF, an AMF is selected in a random fashion according to a local policy, and a registration request is forwarded to the selected AMF. If the selected AMF is unable to service the UE, the selected AMF selects another AMF that is more appropriate for the UE.

3) The RAN transmits an N2 message to the new AMF. The N2 message includes an N2 parameter and a registration request. The registration request may include a registration type, a subscription permanent ID or a temporary user ID, a security parameter, NSSAI, and MICO mode default configuration.

When 5G-RAN is used, the N2 parameter includes location information, cell identifier, and RAT type associated with the cell the UE is camping on.

If the registration type indicated by the UE is a periodic registration update, steps 4 to 17 to be described below may not be performed.

4) The newly selected AMF may transmit an information request message to the previous AMF.

If the temporary user ID of the UE is included in a registration request message and the serving AMF has changed since the last registration, the new AMF may transmit, to the previous AMF, an information request message including complete registration request information for requesting SUPI and MM context of the UE.

5) The previous AMF transmits an information response message to the newly selected AMF. The information response message may include SUPI, MM context, and SMF information.

Specifically, the previous AMF transmits an information response message including SUPI and MM context of the UE.
If the previous AMF has information on an active PDU session, the previous AMF may include SMF information including the ID of the SMF and a PDU session ID within the information response message.

6) The new AMF transmits an Identity Request message to the UE if SUPI is not provided by the UE or is not retrieved from the previous AMF.

7) The UE transmits an Identity Response message including the SUPI to the new AMF.

8) The AMF may decide to trigger an AUSF. In this case, the AMF may select an AUSF based on the SUPI.

9) The AUSF may start authentication of the UE and a NAS security function.

10) The new AMF may transmit an information response message to the previous AMF.

If the AMF has changed, the new AMF may transmit the information response message to confirm delivery of UE MM context.
If the authentication/security procedure fails, registration is rejected, and the new AMF may transmit a rejection message to the previous AMF.

11) The new AMF may transmit an Identity Request message to the UE.

If PEI has not been provided by the UE or has not been retrieved from the previous AMF, an Identity Request message may be transmitted so that the AMF may search for the PEI.

12) The new AMF checks the ME identifier.

13) If step 14 described below is performed, the new AMF selects the UDM based on the SUPI.

14) If the AMF has changed since the last registration, the AMF does not have valid subscription context for the UE, or the UE provides SUPI that is not looked up for valid context by the AMF, the new AMF starts the Update Location procedure. Alternatively, the Update Location procedure may be started when the UDM initiates Cancel Location for the previous AMF. The previous AMF discards the MM context and notifies as many SMFs as possible of the discarding, and the new AMF generates MM context for the UE after obtaining AMF-related subscription data from the UDM.

If network slicing is used, the AMF obtains allowed NSSAI based on requested NSSAI, UE subscription, and a local policy. If the AMF is not suitable for supporting the allowed NSSAI, the registration request is routed again.

15) The new AMF may select a PCF based on the SUPI.

16) The new AMF transmits a UE Context Establishment Request message to the PCF. The AMF may request an operator policy for the UE from the PCF.

17) The PCF transmits a UE Context Establishment Acknowledged message to the new AMF.

18) The new AMF transmits an N11 request message to the SMF.

Specifically, if the AMF is changed, the new AMF notifies each SMF of the new AMF that services the UE. The AMF verifies the PDU session state from the UE by using available SMF information. If the AMF has changed, the available SMF information may be received from the previous AMF. The new AMF may request the SMF to release a network resource associated with a PDU session not activated in the UE.

19) The new AMF transmits an N11 response message to the SMF.

20) The previous AMF transmits a UE Context Termination Request message to the PCF.

If the previous AMF has previously requested the UE context to be established in the PCF, the previous AMF may delete the UE context from the PCF.

21) The PCF may transmit a UE Context Termination Request message to the previous AMF.

22) The new AMF transmits a registration accept message to the UE. The registration accept message may include a temporary user ID, a registration area, mobility restriction, a PDU session state, NSSAI, a periodic registration update timer, and an allowed MICO mode.

The registration accept message may include allowed NSSAI and information of the mapped NSSAI. The allowed NSSAI on the access type of the UE may be included in an N2 message which includes the registration accept message. The mapped NSSAI is S-NSSAI of the allowed NSSAI mapped to S-NSSAI of NSSAI configured for an HPLMN.

When the AMF allocates a new temporary user ID, the temporary user ID may be further included in the registration accept message. When mobile restriction is applied to the UE, information indicating mobility restriction may be additionally included in the registration accept message. The AMF may include information indicating the PDU session state of the UE in the registration accept message. The UE may remove any internal resource associated with the PDU session not indicated as being active in a received PDU session state. If PDU session state information is included in the Registration Request, the AMF may include information indicating the PDU session state to the UE within the registration accept message.

23) The UE transmits a registration complete message to the new AMF.

<PDU Session Establishment Procedure>

There are two types of Protocol Data Unit (PDU) session establishment procedures as follows.
A PDU session establishment procedure initiated by a UE
A PDU session establishment procedure initiated by a network. To this end, the network may transmit a device trigger message to an application(s) of the UE.

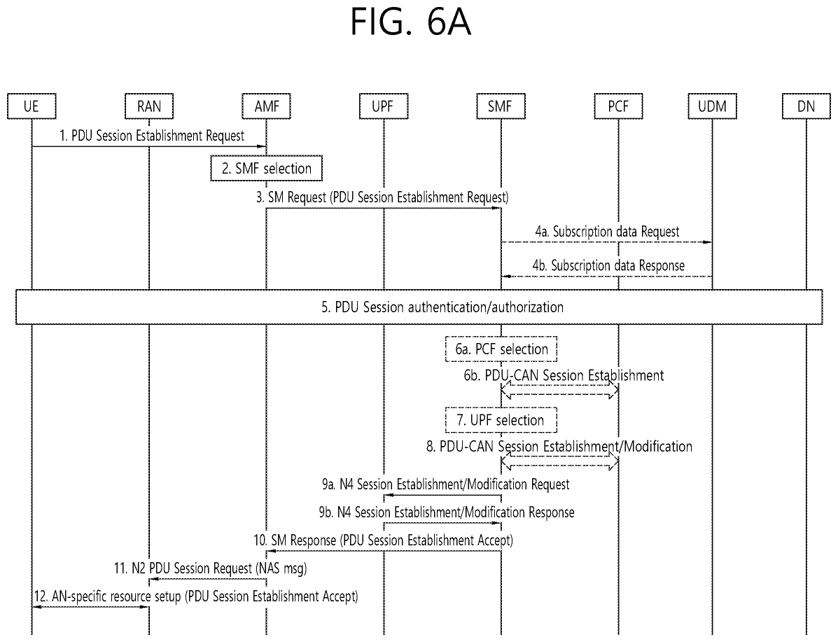

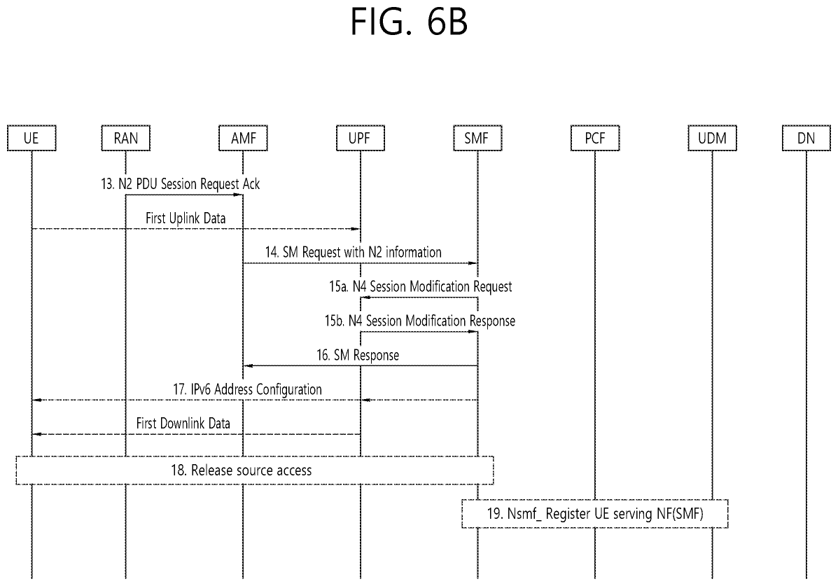

FIGS. 6a and 6b are signal flows of an exemplary PDU session establishment procedure.

The procedures shown in FIGS. 6a and 6b assume that the UE has already registered for the AMF according to the registration procedure described with reference to FIG. 5. Therefore, it is assumed that the AMF has already obtained user subscription data from the UDM.

1) The UE transmits a NAS message to the AMF. The message may include Session Network Slice Selection Assistance Information (S-NSSAI), DNN, PDU session ID, request type, and N1 SM information.

Specifically, the UE includes S-NSSAI from allowed NSSAI of a current access type. If information on the mapped NSSAI has been provided to the UE, the UE may provide both S-NSSAI based on the allowed NSSAI and the corresponding S-NSSAI based on the mapped NSSAI. Here, the mapped NSSAI is S-NSSAI of the allowed NSSAI mapped to S-NSSAI of NSSAI configured for an HPLMN.

More specifically, the UE may extract and store allowed S-NSSAI and the mapped S-NSSAI, which are included in the registration accept message received from the network (namely, AMF) in the registration procedure of FIG. 5. Therefore, the UE may transmit the PDU Session Establishment Request message by including both S-NSSAI based on the allowed NSSAI and the corresponding S-NSSAI based on the mapped NSSAI therein.

To establish a new PDU session, the UE may generate a new PDU session ID.

The UE may start the PDU session establishment procedure initiated by the UE by transmitting a NAS message that includes the PDU Session Establishment Request message in the N1 SM information. The PDU Session Establishment Request message may include a request type, an SSC mode, and a protocol configuration option.

IF PDU session establishment is intended for establishing a new PDU session, the request type represents an “initial request”. However, if there is an existing PDU session between 3GPP access and non-3GPP access, the request type may represent an “existing PDU session”.

ANAS message transmitted by the UE is encapsulated in an N2 message by the AN. The N2 message may be transmitted to the AMF and include user location information and access technology type information.
The N1 SM information may include an SM PDU DN request container that includes information on PDU session authentication by an external DN.

2) If the request type is the “initial request” and the PDU session ID has not been used for an existing PDU session of the UE, the AMF may determine that the message corresponds to a request for a new PDU session.

If the NAS message does not include S-NSSAI, the AMF may determine default S-NSSAI on a PDU session requested according to UE subscription. The AMF may associate and store the PDU session ID with the SMF ID.

3) The AMF transmits an SM request message to the SMF. The SM request message may include a subscription permanent ID, DNN, S-NSSAI, PDU session ID, AMF ID, N1 SM information, user location information, and access technology type. The N1 SM information may include a PDU session ID and a PDU Session Establishment Request message.

The AMF ID is used for identifying an AMF that services the UE. The N1 SM information may include a PDU Session Establishment Request message received from the UE.

4a) The SMF transmits a Subscription data Request message to the UDM. The Subscription data Request message may include a subscription permanent ID and a DNN.

If the request type is “existing PDU session” in the step 3, the SMF determines that the corresponding request originates from handover between 3GPP access and non-3GPP access. The SMF may identify an existing PDU session based on the PDU session ID.

If the SMF has not yet retrieved SM-related subscription data for the UE associated with the DNN, the SMF may request subscription data.

4b) The UDM may transmit a Subscription data Response data to the SMF.

The subscription data may include information about an authenticated request type, an authenticated SSC mode, and a default QoS profile.

The SMF may check whether the UE request conforms to user subscription and local policy. Or, the SMF rejects the UE request through NAS SM signaling (including a cause of rejecting related SM) transmitted by the AMF and informs the AMF that the PDU session ID has to be regarded as being released.

5) The SMF transmits a message to the DN via the UPF.

Specifically, when the SMF has to approve/authenticate establishment of the PDU session, the SMF selects the UPF and triggers the PDU.

If PDU session establishment authentication/authorization fails, the SMF terminates the PDU session establishment procedure and notifies the UE of the rejection.

6a) If dynamic PCC is deployed, the SMF chooses a PCF.

6b) The SMF may start establishing a PDU-CAN session towards the PCF to obtain basic PCC rules for the PDU session. If the request type in the step 3 indicates “existing PDU session”, the PCF may start modifying the PDU-CAN session instead.

7) If the request type of the step 3 indicates “initial request”, the SMF selects the SSC mode for the PDU session. If step 5 is not performed, the SMF may also select the UPF. When the request type is IPv4 or IPv6, the SMF may assign an IP address/prefix for the PDU session.

If dynamic PCC is deployed and PDU-CAN session establishment has not been completed yet, the SMF may start the PDU-CAN session.

9) If the request type indicates “initial request” and step 5 is not performed, the SMF may start the N4 session establishment procedure using the selected UPF, otherwise the N4 session modification procedure may be started using the selected UPF.

9a) The SMF transmits an N4 Session Establishment/Modification Request message to the UPF. In addition, the SMF may provide a packet detection, enforcement, and reporting rule to be installed in the UPF for the PDU session. If CN tunnel information is assigned to the SMF, the CN tunnel information may be provided to the UPF.

9b) The UPF may respond by sending an N4 Session Establishment/Modification Response message. If CN tunnel information is allocated by the UPF, the CN tunnel information may be provided to the SMF.

10) The SMF transmits an SM response message to the AMF. The message may include a cause, N2 SM information, and N1 SM information. The N2 SM information may include a PDU session ID, a QoS profile, and CN tunnel information. The N1 SM information may include a PDU Session Establishment Accept message. The PDU Session Establishment Accept message may include an allowed QoS rule, an SSC mode, S-NSSAI, and an assigned IPv4 address.

The N2 SM information is information that has to be transmitted to the RAN by the AMF, which includes the following.
CN tunnel information: This corresponds to a core network address of the N3 tunnel corresponding to the PDU session.
QoS Profile: This is used to provide the RAN with a mapping relationship between QoS parameters and QoS flow identifiers.
PDU Session ID: This may be used to indicate, to the UE, association between AN resources for the UE and PDU sessions by AN signaling for the UE.

Meanwhile, the N1 SM information includes a PDU Session Accept message that AMF has to provide to the UE.

Multiple QoS rules may be included in the N1 SM information and the N2 SM information in the PDU Session Establishment Accept message.
The SM response message also includes the PDU session ID and information about not only a target UE but also which access has to be used by the AMF for the UE.

11) The AMF transmits an N2 PDU Session Request message to the RAN. The message may include N2 SM information and a NAS message. The NAS message may include a PDU session ID and a PDU Session Establishment Accept message.

The AMF may transmit a NAS message including the PDU session ID and the PDU Session Establishment Accept message. Also, the AMF transmits the N2 SM information received from the SMF to the RAN by including the received N2 SM information in the N2 PDU Session Request message.

12) The RAN may perform specific signaling exchange with a UE related to the information received from the SMF.

The RAN also assigns RAN N3 tunnel information for the PDU session.

The RAN transmits the NAS message provided in the step 10 to the UE. The NAS message may include a PDU session ID and N1 SM information. The N1 SM information may include a PDU Session Establishment Accept message.

The RAN transmits a NAS message to the UE only if necessary RAN resources are established and RAN tunnel information is successfully allocated.

13) The RAN transmits an N2 PDU Session Response message to the AMF. The message may include a PDU session ID, a cause, and N2 SM information. The N2 SM information may include a PDU session ID, (AN) tunnel information, and a list of allowed/rejected QoS profiles.
RAN tunnel information may correspond to an access network address of an N3 tunnel corresponding to the PDU session.

14) The AMF may transmit an SM request message to the SMF. The SM request message may include N2 SM information. Here, the AMF may be to transmit the N2 SM information received from the RAN to the SMF.

15a) If the N4 session for the PDU session has not already been established, the SMF may start the N4 session establishment procedure together with the UPF. Otherwise, the SMF may use the UPF to initiate the N4 session modification procedure. The SMF may provide AN tunnel information and CN tunnel information. The CN tunnel information may be provided only if the SMF selects the CN tunnel information in step 8.

15b) The UPF may transmit an N4 Session Establishment/Modification Response message to the SMF.

16) The SMF may transmit an SM response message to the AMF. At the end of this step, the AMF may forward a related event to the SMF. The event occurs when RAN tunnel information is changed or at the time of handover where the AMF is relocated.

17) The SMF transmits information to the UE via the UPF. Specifically, in the case of PDU Type IPv6, the SMF may generate IPv6 Router Advertisement and transmit the generated IPv6 Router Advertisement to the UE through N4 and the UPF.

18) If the PDU Session Establishment Request originates from handover between 3GPP access and non-3GPP access, namely, if the request type is set to “existing PDU session”, the SMF releases the user plane through source access (3GPP or non-3GPP access).

19) If the ID of the SMF is not included in the step 4b by the UDM of the DNN subscription context, the SMF may call “UDM Register UE serving NF service” by using the SMF address and the DNN. The UDM may store the ID, the address and the associated DNN of the SMF.

If PDU session establishment is not successful during the step, the SMF informs the AMF of the unsuccessful PDU session establishment.

<Roaming in Next Generation Mobile Communication Network>

Meanwhile, there are two ways of handling signaling requests from the UE in a situation where the UE roams to a visited network, for example, a Visited Public Land Mobile Network (VPLMN). The first method, the local break out (LBO) method, processes signaling requests from the UE in the visited network. According to the second method, the home routing (HR) method, the visited network transmits a signaling request from the UE to the home network of the UE.

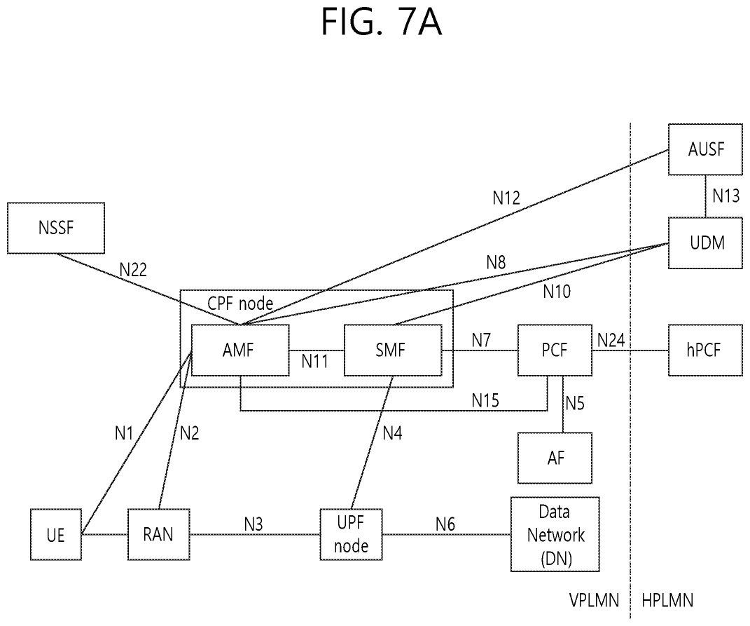

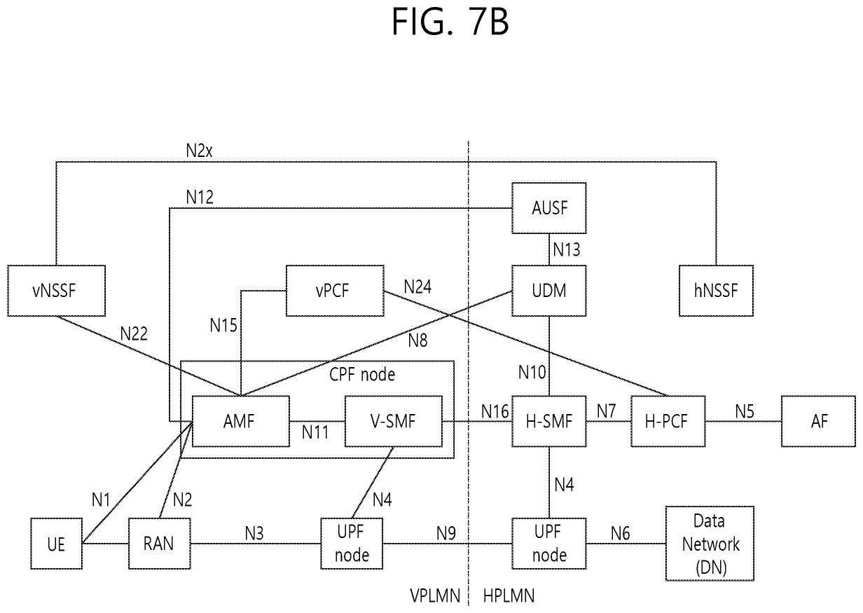

FIG. 7a illustrates an architecture to which a local breakout (LBO) scheme is applied during roaming, and FIG. 7b illustrates an architecture to which a home routed (HR) scheme is applied during roaming.

As shown in FIG. 7a, in the architecture to which the LBO scheme is applied, user data is transferred to a data network in a VPLMN. To this end, the PCF in the VPLMN interacts with the AF to generate a PCC rule for a service in the VPLMN. The PCF node in the VPLMN generates a PCC rule based on a policy set therein according to a roaming agreement with a Home Public Land Mobile Network (HPLMN) operator.

As shown in FIG. 7b, in the architecture to which the HR scheme is applied, data of the UE is delivered to a data network in the HPLMN.

<Data Routing Via Non-3GPP Network>

In the next generation mobile communication, data of a UE may be routed via a non-3GPP network, for example, Wireless Local Area Network (WLAN) or Wi-Fi.

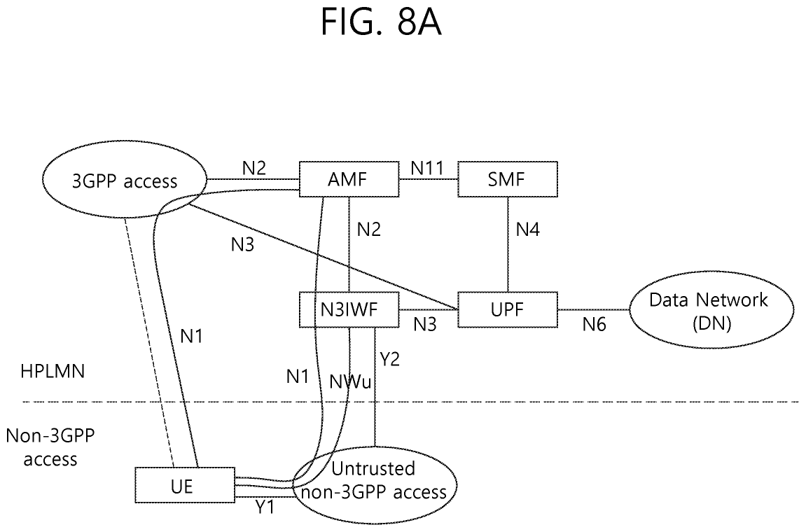

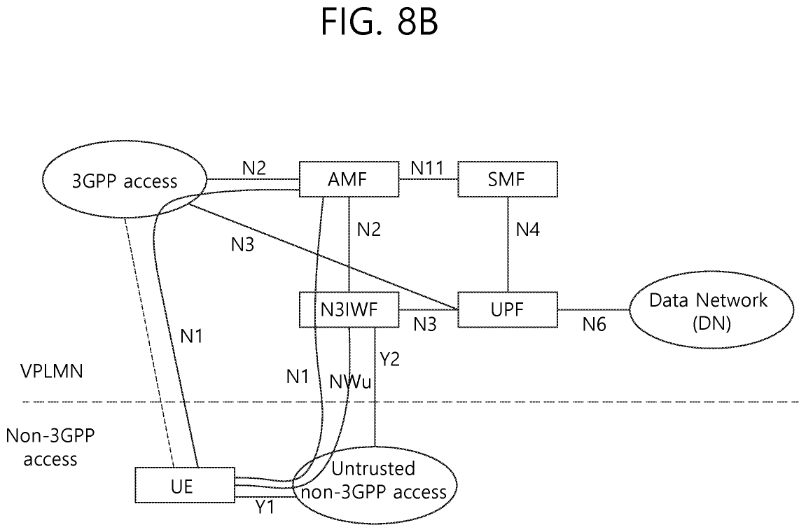

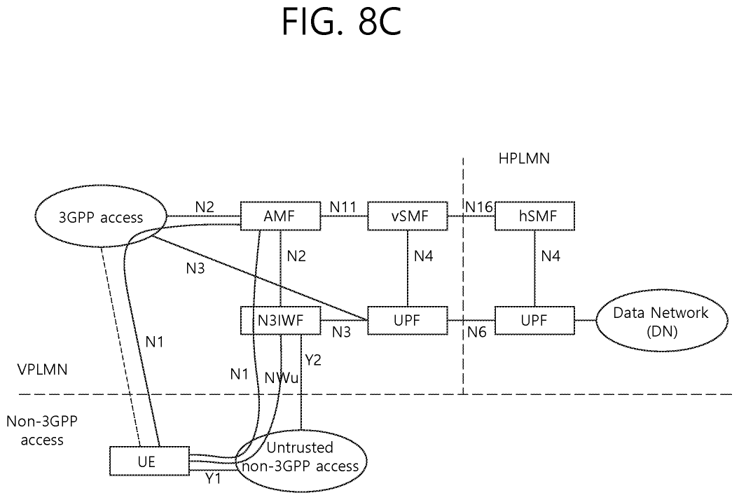

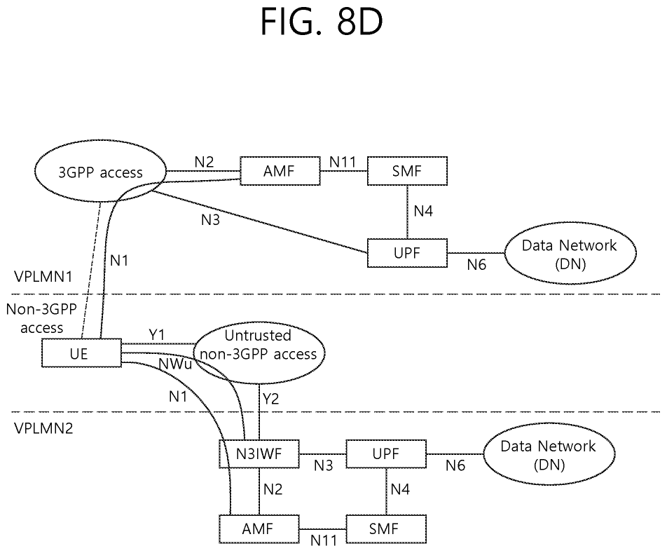

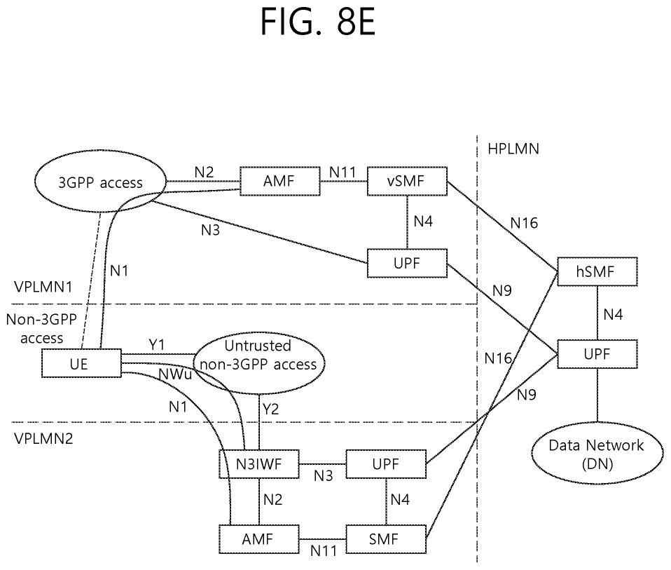

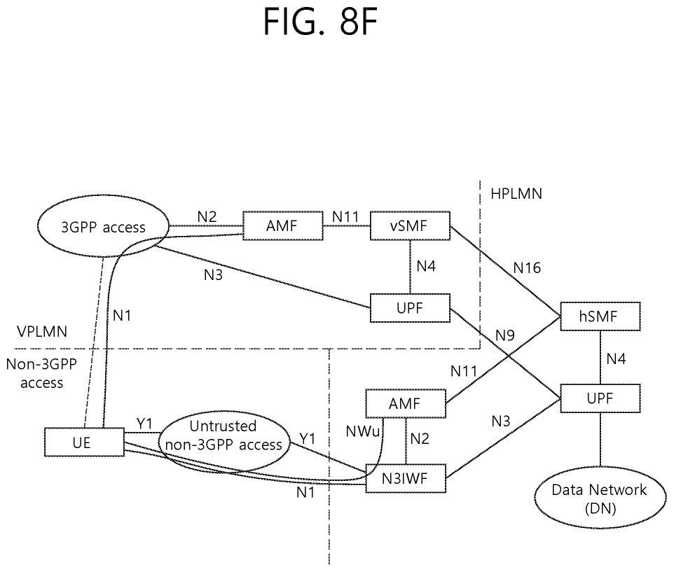

FIGS. 8a to 8f are architectures for routing data via non-3GPP access.

WLAN or Wi-Fi is considered to be untrusted non-3GPP access. To connect the non-3 GPP access to a core network, Non-3 GPP InterWorking Function (N3IWF) may be added.

<Session and Service Continuity>

Next generation mobile networks provide various modes to support session and service continuity (SSC).

1) SSC Mode 1

The UPF, which acts as a PDU session anchor during the PDU session establishment process, is retained independently of the access technology (namely, access type and cell). In the case of an IP type PDU session, IP continuity is supported regardless of movement of the UE. SSC mode 1 may be applied to any PDU session type and may be applied to any access type.

2) SSC Mode 2

If the PDU session has one PDU session anchor, the network may trigger release of the PDU session and instruct the UE to establish the same PDU session. During the establishment of the new PDU session, a UPF acting as a PDU session anchor may be newly selected. SSC mode 2 may be applied to any PDU session type and may be applied to any access type.

3) SSC Mode 3

For a PDU session of SSC mode 3, the network may allow the UE to establish a connection using a new PDU session to the same data network before releasing connectivity between the UE and a previous PDU session anchor. When a trigger condition is applied, the network may determine whether to select a PDU session anchor suitable for the new condition of the UE, namely, UPF. SSC mode 3 may be applied to any PDU session type and may be applied to any access type.

4) SSC Mode Selection

An SSC mode selection policy may be used to determine the type of SSC mode associated with the UE's application or the UE's application group.

The service provider may provide the SSC mode selection policy to the UE. The policy may include one or more SSC mode selection policy rules.

<Multi-Access (MA) PDU Session>

In the conventional technology, an MA PDU session is a session capable of providing a service via both 3GPP access and non-3GPP access by using one PDU session.

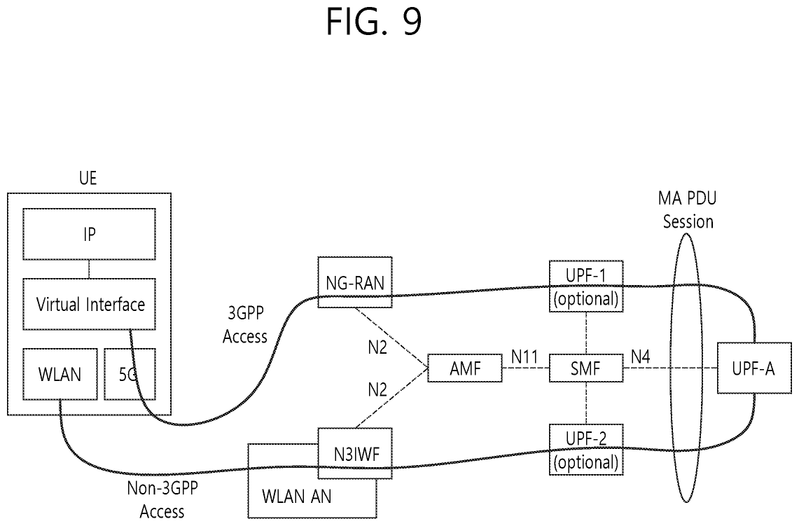

FIG. 9 illustrates an example of generating an MA PDU session.

As shown in FIG. 9, an MA PDU session has a separate session tunnel for each access in one PDU session. One is established on the 3GPP access and the other PDU session is established on the untrusted non-3GPP access (for example, WLAN AN).

Since the MA-PDU session is built on one session, it has the following characteristics.

(i) Single DNN;

(ii) Single UPF anchor (UPF-A);

(iii) Single PDU type (for example, IPv6);

(iv) Single session IP address;

(v) Single SSC mode; and

(vi) Single HPLMN S-NSSAI.

The MA-PDU session allows a multipath datalink between the UE and the UPF-A. The datalink may be implemented in a lower IP layer.

The MA-PDU session may be established through one of the following procedures.

(i) The MA-PDU session may be established through two individual PDU session establishment procedures. This scheme is called individual establishment.

(ii) The MA-PDU session may be established through one MA PDU session establishment procedure. In other words, through a single session generation request, a MA-PDU session is established simultaneously from two accesses. This scheme is called combined establishment.

After a MA-PDU session is established, Session Management (SM) signaling related to the MA-PDU session may be transmitted and received through arbitrary access.

A. Individual Establishment of MA PDU Session

A MA PDU session may be established through two individual PDU session establishment procedures. For example, a UE may establish an MA PDU session on the 3GPP access and then perform a PDU session establishment procedure on the non-3GPP access to add the non-3GPP access to the MA PDU session built on the 3GPP access. The request type within an establishment request message for adding the second access may be configured as “MA PDU request”.

B. Combined Establishment

An MA PDU session may be established on both the 3GPP access and the non-3GPP access through a single procedure. This single procedure may be referred to as an MA PDU session establishment procedure due to a UE request. This procedure may be useful when a UE attempts to establish an MA PDU session while the UE has already registered to the 5GC through two accesses. Instead of performing two individual PDU session establishment procedures, the UE may establish an MA PDU session by performing a single MA PDU session establishment procedure.

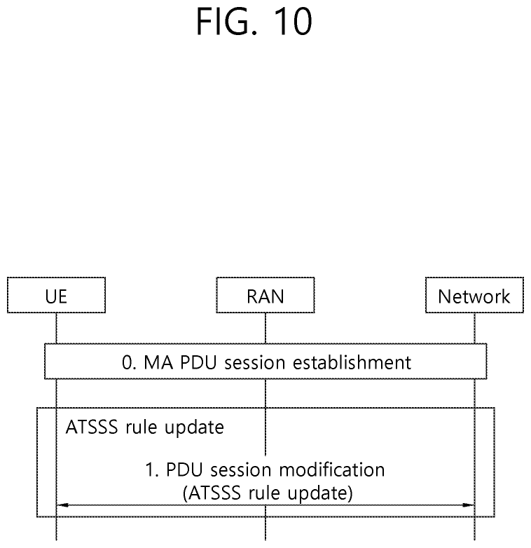

FIG. 10 illustrates an example of applying an ATSSS rule to an MA PDU session.

Referring to FIG. 10, when a Multi-Access (MA) PDU session is established, and the SMF wants to move an IP flow being transferred via non-3GPP access to 3GPP access, an updated Access Traffic Steering, Switching and Splitting (ATSSS) rule may be transmitted through the 3GPP access.

<Problem to be Solved by the Present Disclosure>

Management of an MA-PDU session may be performed as follows.

The UE and the network may measure round trip time (RTT) from both of the two accesses. The measurement may be performed when a specific condition is employed; for example, when the UE employs a valid ATSSS rule.

In order for the aforementioned measurement to be performed properly, a network node should be able to know if specific access to which the MA-PDU session is connected becomes available or unavailable.

When the UE maintains registration through one of the accesses but performs deregistration through the other access, the AMP may inform the SMF of the type of access incapable of using the MA-PDU session. Then, the SMF may inform the UPF of the access type.

1. First Problem

As described above, when a UE performs registration or registration release, the AMF notifies the SMF that the UE is registered or being released from registration. However, unavailable access may also occur when the UE gets out of coverage or a radio link failure (RLF) occurs due to a temporary change of channel conditions in addition to the case where the UE performs registration release. Also, if the UE is out of coverage of non-3GPP access, since the UE transitions to the CM-IDLE state and does not perform registration release, the SMF is unable to know that the UE is incapable of using an MA-PDU session through non-3GPP access.

In other words, there is a problem that a network node, for example, the SMF is unable to know exactly whether specific access to which the MA-PDU session is connected becomes available or unavailable.

This problem causes another problem that the SMF becomes incapable of determining traffic steering for the MA PDU session, switching, and splitting of the MA PDU session.

Meanwhile, a concept similar to the MA PDU session has been once defined for the EPC of the 4th generation mobile communication by the term of Network-Based IP Flow Mobility (NBIFOM). According to the NBIFOM, when any one access became available or unavailable, the UE was able to inform the P-GW of the corresponding information through a control signal. Specifically, when particular access became available, the UE transmitted an indication through the corresponding access while, when particular access became unavailable, the UE was still able to transmit an indication through another access. More specifically, the UE transmitted the indication by using NAS signaling when 3GPP access is utilized. However, in the EPC to which the NBIFOM is applied, since NAS signaling was not supported for non-3GPP access, there was a problem that it was not possible to transmit the indication. Also, in the EPC to which the NBIFOM is applied, since a control signal was transmitted and received between the UE and the network node, there was a problem that network resources were wasted.

2. Second Problem

Meanwhile, there is a problem that downlink packets may be lost if the UE is in the idle state during a process for setting up user plane resources. For example, suppose the UE roams to a visited network (for example, VPLMN) according to the home routed (HR) scheme, and the UE has access to an MA PDU session. At this time, H-SMF and H-UPF belonging to the home network (for example, HPLMN) do not know whether the UE is in the idle state, namely, CM-IDLE or in a connected state, namely, CM-CONNECTED. Suppose further that the UE is in the CM-IDLE state on non-3GPP access. To transmit downlink data to the UE via the non-3GPP access, H-UPF may transmit the downlink data to V-UPF. However, since the UE is in the CM-IDLE state and there is no downlink tunnel, the V-UPF informs the SMF that there is downlink data. The SMF requests the AMF to transmit N2 information via non-3 GPP access for setting up of user plane resources. However, since the UE is in the CM-IDLE state on the non-3GPP access, the AMF is unable to handle the request. Therefore, the AMF informs the SMF that the UE is in an unreachable state. In this case, data (packet) transmitted to the V-UPF is not transmitted to the UE and is subsequently lost.

For normal cases, when the UE is unable to use specific access (for example, the UE is out of coverage), a report is transmitted through the user plane, which notifies of unavailability of the specific access. Therefore, if the UE is in the CM-IDLE state on the non-3GPP access, the UE may prevent the H-UPF from transmitting data via non-3GPP access by transmitting a report via 3GPP access, which notifies that the non-3GPP access is unavailable. However, if downlink data is transmitted before the UE transmits the report notifying of the unavailability of the non-3GPP access, the downlink data may be lost. This problem may also be occurred when the UE stays in a non-allowed area for 3GPP access. In other words, H-SMF and H-UPF may not know whether the UE is in the non-allowed area. Therefore, if the downlink data is transmitted via 3GPP access, since user plane resources may not be set up for the 3GPP access in the non-allowed area, data is lost. Also, even when there is I-UPF, the anchor UPF is unable to determine whether the UE is in the CM-IDLE state, which causes the same problem.

To solve the problem above, a method for the AMF to notify the H-SMF whether the UE is in the CM-IDLE state may be considered. However, this method is still unable to solve the aforementioned problem when the UE stays in a non-allowed area. Also, the problem above occurs even when there exists an I-SMF under a non-roaming situation. Since the relationship between the I-SMF and the SMF is similar to that between the V-SMF and the H-SMF, the same problem occurs. Also, when there exists another UPF independently of an anchor UPF that performs ATSSS even when there is no I-SMF or V-SMF, namely, when there exist an I-UPF without an N3 tunnel being connected to the anchor UPF, the same problem occurs.

<Disclosure of the Present Disclosure>

The present disclosure is intended to provide a method for a network node to effectively figure out the state of access through which an MA PDU session is connected in the 5th generation mobile communication system.

The disclosures of the present disclosure described below may be implemented by one or more combinations. Although each drawing illustrates an embodiment of each disclosure, embodiments in the drawing may be combined to be implemented.

I. First Disclosure of the Present Disclosure

In what follows, a first disclosure of the present disclosure to solve the first problem above will be described.

In what follows, various methods of the first disclosure described below may be implemented by one or more combinations. Although each drawing illustrates an embodiment of each disclosure, embodiments in the drawing may be combined to be implemented.

I-1. First Method of the First Disclosure: UE Notifies Through User Plane (UP)

The first method of the first embodiment discloses a method for transmitting a report to the UPF through the user plane (UP) when the UE has access to an MA PDU session and either access becomes available or unavailable. The report may be a report for access availability. During a process of establishing the MA PDU session, the SMF may transmit measurement assistance information by including the information in a PDU Session Establishment Accept message. Based on the operation above, the UE may generate a report for arbitrary access and transmit the generated report to the UPF through the user plane (UP). The SMF may include a configuration within the measurement assistance information, which instructs the UE to report whether the UE is in the available and/or unavailable state with respect to specific access. Or, even without a configuration by the SMF (namely, even without the measurement assistance information), the UE may independently generate and transmit a report when the UE transitions to a state where arbitrary access is available/unavailable. If non-3GPP access is always connected through a wired connection, the SMF may configure so that reporting on the availability (in other words, it indicates whether the access is in an available or unavailable state) of the non-3GPP access is not performed.

If the UPF receives, from the UE, a report including the availability (in other words, it indicates whether the access is in an available or unavailable state) of arbitrary access, the UPF may inform the SMF of the received report. The SMF, which receives the report, may perform traffic steering, switching, and splitting for uplink and downlink traffic through the ATSSS rule and/or N4 rule update.

The SMF may use measurement assistance information to determine availability of arbitrary access for the UE. For example, the measurement assistance information may include a reference for received signal strength, for example, information such as a threshold for RSRP and/or RSRQ. In this case, if received signal strength of WLAN is larger than a predetermined threshold, the UE may determine that the corresponding access is available whereas, if less than the predetermined threshold, the UE may determine that the access is unavailable. Or, the UE may independently determine the availability of arbitrary access. Specifically, if the UE performs registration or enters WLAN coverage via specific access, the UE may determine that the access is in the available state. On the other hand, if the UE performs registration release or gets out of WLAN coverage through specific access, the UE may determine that the access is in the unavailable state.

To this end, the UE may have to activate the user plane (UP) for the MA PDU session. For example, suppose the UE is in the CM-IDLE state in the 3GPP access to which the MA PDU session is connected because there is no data transmission but transmits and receives data through non-3GPP access (namely, WLAN). If the UE leaves coverage of the non-3GPP access (namely, WLAN), the UE has to transmit a report including availability of the non-3GPP access through the 3GPP access. In this case, the report has to be transmitted through the user plane (UP). Therefore, by transmitting a service request message through the 3GPP access, the UE activates the PDU session and transmits the report when the PDU session is activated.

In what follows, described will be an example where the UE is prevented from using 3GPP access while the UE is using both 3GPP access and non-3GPP access after the UE generates an MA PDU session. For example, a scenario may be assumed, where the UE generates an MA PDU session and handles an IP Multimedia Subsystem (IMS)-based voice call through 3GPP access. In this case, although the network sets up a Guaranteed Bit Rate (GBR) QoS flow through 3GPP access that guarantees Quality of Service (QoS) and services an IMS-based voice call, an MA PDU session may be utilized to provide the voice call service seamlessly through non-3GPP access in case 3GPP access is disconnected.

I-1-1. MA PDU Session Establishment

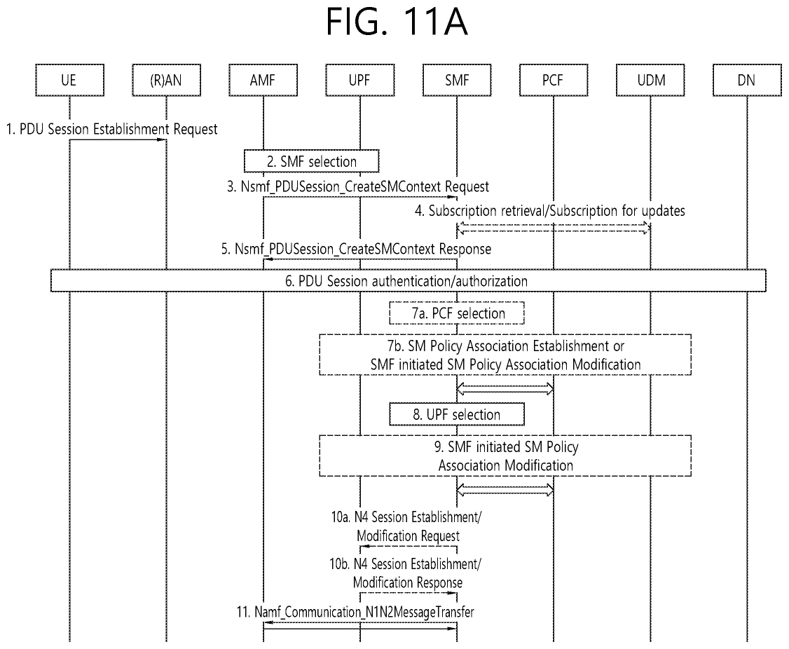

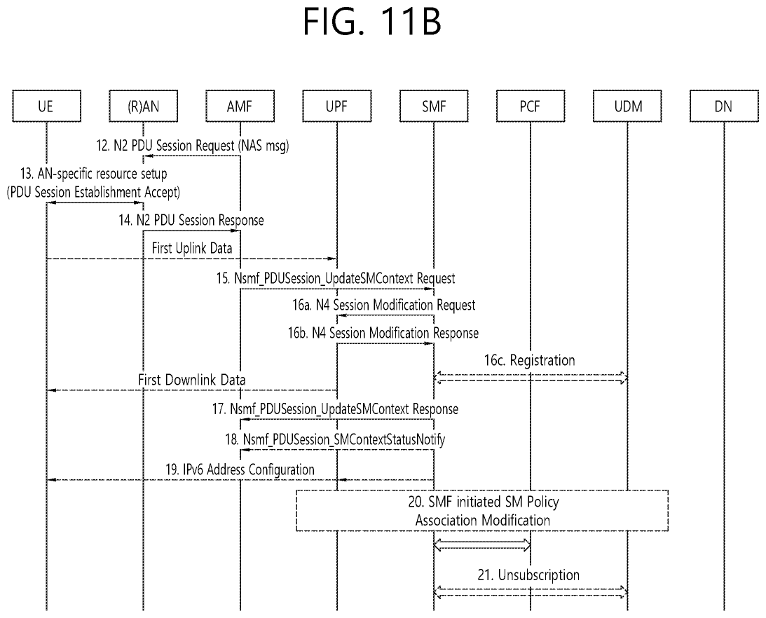

FIGS. 11a and 11b are signal flows of a PDU session establishment procedure.

The PDU session establishment procedure shown in FIGS. 11a and 11b are similar to the PDU session establishment procedure shown in FIGS. 6a and 6b. In what follows, therefore, only those different parts will be mainly described.

1) The UE may start the PDU session establishment procedure initiated by the UE by transmitting a NAS message that includes the PDU Session Establishment Request message in the N1 SM information.

The PDU Session Establishment Request message may include an indication notifying of a request for an MA PDU session.

3) If receiving the PDU Session Establishment Request message, the SMF may know from the indication that the UE has requested an MA PDU session.

10) If the SMF wants to receive a report on availability (available state or unavailable state) of arbitrary access, the SMF may transmit associated configuration information while transmitting a Session Reporting Rule (SRR) to the UPF.

11) If establishment of the MA PDU session is allowed, the SMF transmits a PDU Session Establishment Accept message. If the SMF wants to receive a report on availability of arbitrary access (available state or unavailable state), the SMF may transmit an indication/configuration information notifying that the SMF wants to receive a report on the access availability by including the indication/configuration information in the PDU Session Establishment Accept message.

13) To transmit a report including availability of one of 3GPP access and/or non-3GPP access, The UE performs monitoring of the access based on the indication/configuration information within the PDU Session Establishment Accept message. In other words, the UE measures received signal strength or channel quality from the access.

16) If the configuration information is not transmitted to the UPF in the step 10, the SMF may transmit, to the UPF, the Session Report Rule (SRR) that includes associated configuration information for receiving a report on the availability (available state or unavailable state) of arbitrary access.

I-1-2. Report on Availability of 3GPP Access

After an MA PDA session is established, the UE may start an IMS-based voice call.

For example, when the UE gets out of coverage of 3GPP access (for example, when the UE enters a building or an underground facility), the UE may determine that 3GPP access has turned into the unavailable state. Then, the UE may transmit, through the user plane (UP) of non-3GPP access, a report notifying that the 3GPP access is in the unavailable state.

I-1-3. UPF Reports an Event to SMF

As described above, the UPF may receive, from the SMF, the SRR that includes associated configuration information for obtaining a report on availability (available state or unavailable state) of arbitrary access.

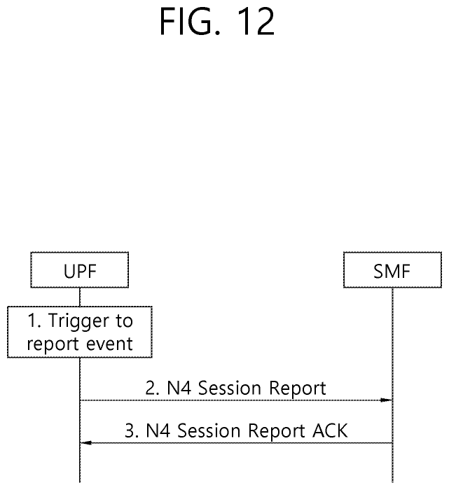

FIG. 12 illustrates a procedure for an UPF to report an availability state to an SMF.

As may be seen from FIG. 12, if the UPF receives a report on the availability from the UE, the UPF triggers an event report based on the associated configuration information.

The UPF may transmit an N4 session report message including a report on the availability to the SMF.

I-1-4. N4 Rule, ATSSS Rule, QoS Rule, and QoS Flow Update by SMF

If the SMF recognizes that 3GPP access has become unavailable, the SMF updates the ATSSS rule and the QoS rule of the UE to maintain a service provided to the UE through non-3GPP access and to forward a GBR QoS flow to the non-3GPP access. Also, by updating the N4 rule, the SMF updates QoS flow information of the UPF and traffic steering rule.

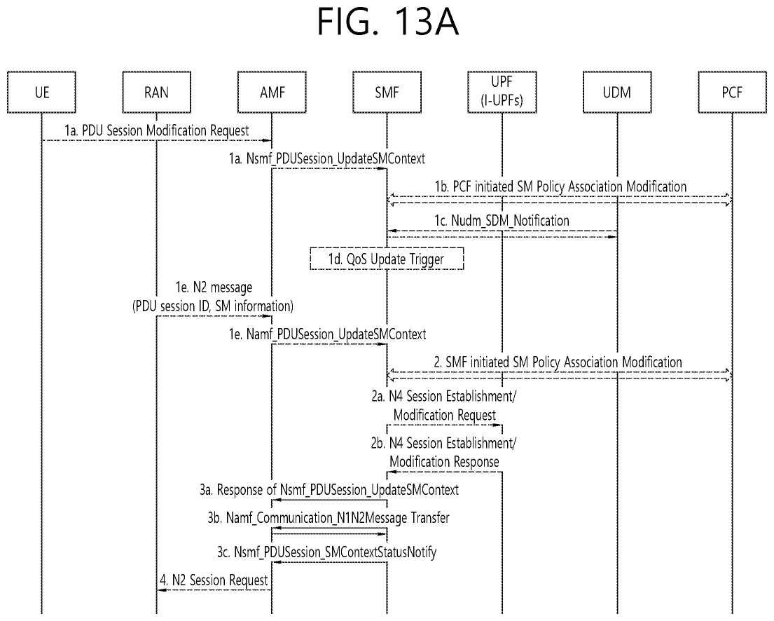

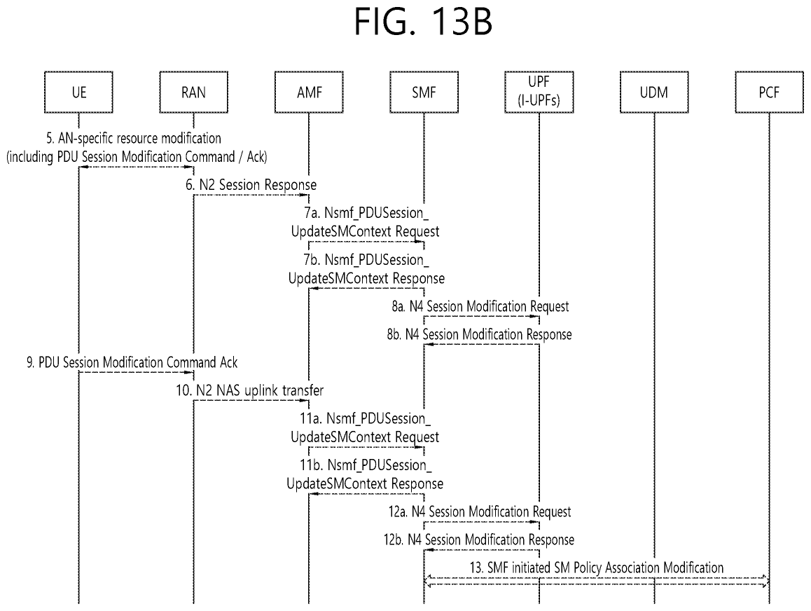

This process may be performed through a PDU Session Modification procedure. The PDU Session Modification procedure will be described with reference to FIGS. 13a and 13b.

FIGS. 13a and 13b illustrate a procedure for modifying a PDU session.

The PDU Session Modification procedure may be initiated by the UE or by the network.

1a) The UE may initiate the PDU Session Modification procedure by transmitting an NAS message. The NAS message may include an N1 SM container. The N1 SM container may include a PDU Session Modification Request message, a PDU session ID, and information on integrity protection maximum data rate of the UE. The PDU Session Modification Request message may include a PDU session ID, a packet filter, information on requested QoS, 5GSM core network capability, and the number of packet filters. The integrity protection maximum data rate of the UE represents the maximum data rate allowed for the UE to support UP integrity protection. The number of packet filters represents the number of packet filters supported for a QoS rule.

The NAS message is transmitted to an appropriate AMF via the RAN according to the location information of the UE. Then the AMF transmits Nsmf_PDUSession_UpdateSMContext message to the SMF. The message may include a Session Management (SM) context ID and an N1 SM container. The N1 SM container may include a PDU Session Modification Request message.

1b) If the PDU Session Modification procedure is initiated by the PCF among network nodes, the PCF may notify the SMF of a policy change by initiating an SM Policy Association Modification procedure.

1c) If the PDU Session Modification procedure is initiated by the UDM among network nodes, the UDM may update subscription data of the SMF by transmitting Nudm_SDM_Notification message. The SMF may update session management subscription data and transmit an ACK message to the UDM.

1d) If the PDU Session Modification procedure is initiated by the SMF among network nodes, the SMF may trigger a QoS update.

If the PDU Session Modification procedure is triggered according to 1a to 1d cases, the SMF may perform the PDU Session Modification procedure.

1e) If the PDU Session Modification procedure is initiated by the AN among network nodes and AN resources to which a QoS flow is mapped are released, the AN may notify the SMF of the resource release. The AN may transmit an N2 message to the AMF. The N2 message may include a PDU session ID and N2 SM information. The N2 SM information may include QFI, user location information, and an indication indicating release of a QoS flow. The AMF may transmit Nsmf_PDUSession_UpdateSMContext message. The message may include an SM context ID and N2 SM information.

2) The SMF may transmit a report on a subscription event by performing an SM Policy Association Modification procedure. If the PDU Session Modification procedure is triggered by 1b to 1d cases, this step may be skipped. If dynamic PCC is not deployed over the network, the SMF may apply an internal policy to determine the change of the QoS profile.

The steps 3 to 7 described below may not be performed when the PDU Session Modification procedure requires only the operation of the UPF.

3a) If the UE or the AN initiates the PDU Session Modification procedure, the SMF may respond to the AMF by transmitting Nsmf_PDUSession_UpdateSMContext message. The message may include N2 SM information and an N2 SM container. The N2 SM information may include a PDU session ID, QFI, a QoS profile, and a session-AMBR. The N1 SM container may include a PDU session modification command. The PDU session modification command may include a PDU session ID, a QoS rule, a QoS rule operation, QoS parameters at QoS flow level, and a session-AMBR.

The N2 SM information may include information that the AM has to transmit to the AN. The N2 SM information may include QFI and a QoS profile to notify the AN that one or more QoS flows are added or modified. If PDU session modification is requested by a UE for which user plane resources are not configured, the N2 SM information to be transmitted to the AN may include information for establishment of user plane resources.

The N1 SM container may include a PDU Session Modification command to be transmitted to the UE by the AMF. The PDU Session Modification command may include a QoS rule and QoS parameters at QoS flow level.

3b) If the PDU Session Modification procedure is initiated by the SMF, the SMF may transmit Namf_Communication_N1N2MessageTransfer message. The message may include N2 SM information and an N1 SM container. The N2 SM information may include a PDU session ID, QFI, a QoS profile, and a session-AMBR. The N1 SM container may include a PDU session modification command. The PDU session modification command may include a PDU session ID, a QoS rule, and QoS parameters at QoS flow level.

If the UE is in the CM-IDLE state and ATC is in the active state, the AMF may skip steps 3 to 7 described below after updating and storing UE context based on the Namf_Communication_N1N2MessageTransfer message. If the UE enters a reachable state, namely, CM-CONNECTED state, the AMF may transmit an N1 message to synchronize the UE with the UE context.

4) The AMF may transmit an N2 PDU Session Request message to the AN. The N2 PDU Session Request message may include the N2 SM information and the NAS message received from the SMF. The NAS message may include a PDU session ID and an N1 SM container. The N1 SM container may include a PDU session modification command.

5) The AN performs AN signaling exchange with a UE associated with the information received from the SMF. For example, in the case of NG-RAN, to modify required AN resources associated with the PDU session, an RRC Connection Reconfiguration procedure may be performed in conjunction with the UE.

6) The AN transmits an N2 PDU session ACK message in response to the received N2 PDU session request. The N2 PDU session ACK message may include N2 SM information and user location information. The N2 SM information may include a list of accepted/rejected QFI, AN tunnel information, and an PDU session ID.

7) The AMF transmits the N2 SM information and the user location information received from the AN through Nsmf_PDUSession_UpdateSMContext message. Then the SMF transmits Nsmf_PDUSession_UpdateSMContext message to the AMF.

8) The SMF transmits an N4 Session Modification Request message to the UPF to update the N4 session of the UPF included in the PDU Session Modification command.

If a new QoS flow is generated, the SMF updates an UL packet detection rule of the new QoS flow together with the UPF.

9) The UE transmits an NAS message in response to the reception of the PDU Session Modification command. The NAS message may include a PDU session ID and an N1 SM container. The N1 SM container may include a PDU Session Modification command ACK.

10) The AN transmits the NAS message to the AMF.

11) The AMF may transmit the N1 SM container and the user location information received from the AN to the SMF through Nsmf_PDUSession_UpdateSMContext message. The N1 SM container may include a PDU Session Modification command ACK. The SMF may transmit Nsmf_PDUSession_UpdateSMContext Response message to the AMF.

12) The SMF transmits an N4 Session Modification Request message to the UPF to update the N4 session of the UPF included in the PDU Session Modification command. The message may include an N4 session ID.

13) When the SMF interacts with the PCF during the step 1b or 2, the SMF may notify the PCF of whether a PCC decision may be performed or not via the SM Policy Association Modification procedure.

The SMF may notify an entity which has requested the user location information related to PDU session modification.

In the step 3, the SMF, while transmitting the PDU Session Modification Command message through non-3GPP access to move a QoS flow via 3GPP access and to update the ATSSS rule and the QoS rule of the UE, transmits the updated ATS SS and QoS rules by including the rules in the message. Also, the SMF transmits an N2 request message for setting up a GBR QoS flow through non-3GPP access.

According to the ATSSS and QoS rules updated in the step 5, the UE may transmit uplink data through non-3GPP access.

The N4 rule of the UPF is updated during the step 8 or 12. At this time, the steering rule may be updated so that traffic may be forwarded through non-3GPP access. Or, an active-standby rule may be set up when an MA PDU session is generated so that at the moment the UE reports that 3GPP access is in the unavailable state, downlink data is set to be forwarded through non-3GPP access.

I-2. Second Method of the First Disclosure: Network Node Determines Access Availability Through Control Plane (CP) Signal

The second method of the first disclosure proposes a method for a network node to determine access availability through event subscription.

If a signal from the access used by the UE is lost, the NG-RAN (including a gNB and an ng-eNB) or the N3IWF may detect the loss and inform the AMF of the detected loss. Then the AMF performs an AN release procedure. During this procedure, if an active PDU session is found, the AMF informs the SMF managing the corresponding PDU session that the PDU session has been deactivated. In this case, the SMF may know which access has been deactivated. However, in the case of home routed (HR)-type roaming, the corresponding signaling is transmitted only to the V-SMF but is not transmitted to the H-SMF, which makes the H-SMF controlling the ATSSS unable to know whether the corresponding access is unavailable or not. Also, if a PDU session is not in the active state, since the AMF does not notify the SMF that the PDU session has been deactivated, the SMF is made unable to recognize the deactivation. Also, there is a problem that if a signal from the corresponding access is lost while the UE is in the CM-IDLE state, the network is unable to recognize the loss.

Also, there is an event called “UE reachability status” among the events provided by the AMF. This event is intended to notify the case where the UE is in the CM-CONNECTED. From the event, the SMF may know access availability of the UE. In other words, when the UE enters coverage of the corresponding access and transitions to the CM-CONNECTED state, the SMF may receive information about the corresponding event from the AMF and know that the state of specific access has become the available state. However, if the UE continues to stay in the CM-IDLE state, the AMF is unable to determine at all whether the access has become available. In this case, although the access is, in fact, available, the SMF continues to determine that the corresponding access is unavailable. At this time, even if more preferred access actually becomes available according to the rule transmitted by the PCF, the SMF still determines that the access is unavailable, and traffic is not allowed to be transmitted through the corresponding access. Moreover, in the case of HR-type roaming, the corresponding event is transmitted only up to the V-SMF but is not transmitted to the H-SMF.

The second method of the first disclosure of the present disclosure proposes the following operations to solve the problems above.

I-2-1. Unavailable State of Access

As described above, if the UE is in the CM-CONNECTED state and the corresponding access becomes unavailable (namely, a signal from the access is lost), the NG-RAN or the N3IWF informs the AMF of the detected state. At this time, specific cause information (for example, Radio connection with UE lost) is transmitted to the AMF. Then the AMF may determine based on the received information that the access is in the unavailable state. Afterwards, the AMF performs an AN release procedure. At this time, even if an MA PDU session is not in the active state, the AMF may transmit information notifying that the corresponding MA PDU session has been deactivated. Alternatively, the AMF may transmit information notifying that it is not the case that the MA PDU session has been deactivated but rather the access is in the unavailable state. This is possible when the AMF is aware of the MA PDU session. If the AMF is not aware of the MA PDU session, the SMF may receive a notification through “UE loss of communication” event provided by the AMF. During a process for establishing an MA PDU session, the SMF may request the AMF to subscribe to the corresponding event. Or, the SMF may request the subscription from the AMF during a process for adding access for an MA PDU session. At this time, the SMF may also provide information on specific access to inform the AMF that the subscription request is related to an event for the corresponding access.

If a signal from access is lost while the UE is in the CM-IDLE state, the network encounters a problem that it is unable to detect the loss. In the case of non-3GPP access, if the UE stays in the coverage of non-3GPP access (namely, WLAN), the UE is always considered to maintain the CM-CONNECTED state, the aforementioned problem may be underestimated. However, in the case of 3GPP access, if the UE does not perform a registration procedure even though the time to perform a periodic registration procedure has come, the AMF may manage to determine that the 3GPP access is in the unavailable state. However, not knowing immediately that the 3GPP access is in the unavailable state does not cause a significant problem. If traffic is transmitted through the corresponding access without knowing that the 3GPP access is in the unavailable state, the SMF requests the AMF to perform an N2 setup. Then the AMF determines from transmission/re-transmission of a paging message that the UE is in the unreachable state and informs the SMF of the UE's state. Then the SMF may determine that the corresponding access is in the unavailable state.

I-2-2. Available State of Access

If the UE enters the CM-CONNECTED state, the AMF may notify the SMF of the UE's state changed. In other words, as described in Section II-1, if the UE enters the CM-CONNECTED state in the corresponding access while the AMF is aware that arbitrary access of the UE is unavailable, the AMF may notify the SMF having access to an MA PDU session that access of the UE has become available. However, if the UE continues to stay in the CM-IDLE state, the AMF does not know availability of the access. To solve this problem, the UE performs a service request procedure if the first access is changed from the unavailable state to the available state (for example, when the UE gets out of WLAN coverage and again gets into the WLAN coverage or when an RLF occurs in the 3GPP access and the UE again successfully camps on a base station). The UE transmits a service request message to the AMF through first access which has changed to the available state. The service request message may explicitly or implicitly include information for notifying that the first access is in the available state. The service request message may be transmitted through second access, different from the first access. In this case, the service request message may explicitly or implicitly include information notifying which access has become available. The service request message may also include information on the MA PDU session. At this time, if there is no uplink traffic, the UE may transmit an activation request for the MA PDU session or other PDU sessions without including the activation request in the service request message. In other words, the UE may exclude “List Of PDU Sessions To Be Activated” or Uplink data status from the service request message. Accordingly, even though the UE has to stay in the CM-IDLE state due to absence of uplink traffic and/or uplink signaling, the UE is made to perform the service request procedure to notify of availability of access to the network. By doing so, the AMF may determine that the corresponding access of the UE has become available and may notify the SMF of the availability. To this end, the AMF has to be aware of the MA PDU session and remember whether arbitrary access is in the available state or unavailable state. If the SMF has requested the AMF to subscribe to the event of “UE reachability status”, the SMF may receive a notification about the corresponding event from the AMF. At this time, the SMF may also provide information on specific access to inform the AMF that the subscription request is related to an event for the corresponding access.

In the description above, it was assumed that the UE transmits a service request message to notify the network of access availability; however, the UE may also transmit a registration request message or alternatively, an NAS message.

In the descriptions of Sections I-2-1 and I-2-2, it should be noted that in order for the corresponding event to be transmitted up to the H-SMF, subscription to the events of “UE loss of communication” and “UE reachability status” supported between the AMF and the SMF has to be supported in the same manner between the H-SMF and the V-SMF. Also, if the SMF obtains information on the availability of access, the SMF may notify the UPF of the obtained information so that traffic steering, switching, and splitting may be performed without a problem according to the N4 rule.

I-3. Third Method of the First Disclosure: Combination of the First and the Second Methods

The first method and the second method of the first disclosure may be combined. According to the second method of the first disclosure, information on the availability of access may be transmitted with some delay. Therefore, if arbitrary access becomes unavailable, the UE may transmit a report through the user plane (UP) according to the first method of the first disclosure. However, if access becomes available, reporting may be performed according to the second method of the first disclosure.

I-4. Example of Implementation of the First Disclosure

In what follows, an example of improving the 3GPP standard according to each of the first and second methods of the first disclosure and/or a combination thereof will be described.

I-4-1. Addition of User Plane Resource/Reactivating/Deactivating

(a) When the UE has established an MA PDU session but user plane resources are not set up on one of accesses for the MA PDU session,
If the UE wants to add user plane resources on the access, the UE starts a PDU Session Establishment procedure on the access. To this end, the UE transmits an UL NAS Transport message. The UL NAS Transport message may include an indication indicating “MA PDU Request” and the same PDU session ID as that of an existing MA PDU session.
The UE receives a PDU Session Establishment Accept message. The PDU Session Establishment Accept message may include an ATSSS rule updated by the MA PDU session.
Meanwhile, if the SMF receives the PDU Session Establishment Request message through the access and the SMF already has SM context for the access, the SMF does not release the existing SM context but re-activates user plane resources on the access and transmits the PDU Session Establishment Accept message to the UE.

(b) If, although the UE has established an MA PDU session, the user plane resources are in the inactive state on one of the accesses (namely, when the UE is in the CM-IDLE state on the access),
If the UE wants to re-activate user plane resources on the access, the UE may initiate a registration procedure or a service request procedure through the access.
If a network node wants to re-activate the user plane resources on the 3GPP access or the non-3GPP access for the MA PDU session, the network node may initiate the service request procedure.
If the AMF determines that the UE is in the unreachable state (for example, the state where the UE is in the CM-IDLE state on the non-3GPP access or the state where the AMF is unable to receive, from the UE, a response message with respect to a paging message transmitted by the AMF), the AMF may reject a request from the SMF. In this case, the SMF may initiate an N4 Session Modification procedure to notify the UPF that the user plane resources on the 3GPP access and/or non-3GPP access are in the unavailable state.

I-4-2. Operation Updating an Established PDU Session

An operation updating an established PDU session may be performed by Nsmf_PDUSession_Update service operation. For the Nsmf_PDUSession_Update service operation, the descriptions given earlier with reference to FIG. 13 may be applied.

For the operation above, an indication for availability of access (in other words, it indicates whether the access is in an available or unavailable state) may be used.

II. Second Disclosure of the Present Disclosure

In what follows, a second disclosure to solve the second problem will be described.

In what follows, various methods of the second disclosure described below may be implemented by one or more combinations. Although each drawing illustrates an embodiment of each disclosure, embodiments in the drawing may be combined to be implemented.

II-1. First Method of the Second Disclosure: UE Transmits a Report Notifying of Unavailability

The first method of the second disclosure proposes transmitting a report notifying of unavailability of specific access not only when the UE is unable to use the specific access but also when the UE is located within radio coverage but is unable to use the specific access due to other reason (for example, service area restriction). In other words, the first method of the second disclosure proposes transmitting a report notifying of unavailability when the UE is located in a non-allowed area or a forbidden area.

If the UE enters a non-allowed area for 3GPP access, the UE transmits a report notifying of unavailability of 3GPP access to the UPF through non-3GPP access. By doing so, even if the UE is located in the non-allowed area, since the PFU does not transmit data through the corresponding access (namely, 3GPP access), data loss may be prevented. Afterwards, if the UE enters an allowed area for 3GPP access, the UE transmits a report notifying availability of the 3GPP access to the UPF through one ore more accesses between the 3GPP access and/or the non-3GPP access. The UPF may start data transmission through the 3GPP access since reception of the report. The UPF performs the operation above only for an MA PDU and performs the operation above after explicitly or implicitly receiving a report notifying of availability or unavailability of arbitrary access. The UE may not transmit the report when the MA PDU session is set up only on the non-3GPP access. In other words, when it is not the case that the user plane has been deactivated in the 3GPP access but rather a PDU session has not been set up on the 3GPP access, the UE may not transmit the report. For example, although the UE performs registration and generates an MA PDU session only through non-3GPP access, if the UE has not transmitted a PDU Session Establishment Request message through 3GPP access, the UE may not transmit the report. Also, when the UE enters again an allowed area after transmitting a report notifying of unavailability, data traffic is made to be transmitted again through 3GPP access as the UE transmits a report notifying of availability of 3GPP access no matter which access is employed. For the simplicity of implementation, independently of whether the UE has transmitted an unavailability report before, the UE may transmit a report notifying of availability. In the same manner, the unavailability report may be transmitted independently of whether the UE has transmitted a report notifying of availability. In other words, if the UE enters a non-allowed area, the UE may transmit a report notifying of unavailability independently of whether the UE has transmitted a report notifying of availability in an allowed area before.

Since the method described above allows the UE to transmit only the report notifying of availability or unavailability, it provides an advantage that only a small portion of the whole system needs to be improved. In particular, the method provides an advantage that additional signaling between the SMF and the UPF is not necessary. However, the method above prevents loss of data only after the UPF receives a report and other than that, there is still a chance of data loss.

II-2. Second Method of the Second Disclosure: Forwarding Tunnel is Made in the Network for Data Transmission

The second method of the second disclosure solves the data loss problem in the network without involving an additional operation of the UE. In other words, when the UPF requests the SMF to set up user plane resources but setting up of the user plane resources fails, the UPF generates a forwarding tunnel with the V-SMF/I-SMF and transmits data again to the anchor UPF. The anchor UPF, which receives the data, may determine again based on the N4 rule that the data may be transmitted through another access and may transmit the data through the corresponding access according to the determination. To this end, when the forwarding tunnel is generated, which access is intended by the forwarding tunnel has to be informed. Since a normal forwarding tunnel is generated for each PDU session, and a normal PDU session uses a tunnel aimed for one access, no information on access is needed. However, in the case of an MA PDU session, even though the session is counted as a single PDU session, a different tunnel is made for each access; therefore, when a forwarding tunnel is generated, which access is intended by the forwarding tunnel has to be informed.

To this end, while requesting the SMF to set up the user plane, the UPF may inform of which packet the request is related to. In general, when there is no downlink tunnel, the UPF requests the SMF to set up the user plane by transmitting a Data Notification message to the SMF. The Data Notification message may include an N4 session ID, information for identifying a QoS filter for a downlink data packet, and a DSCP. At this time, the Data Notification message does not include specific information on the downlink data, for example, TFT/application ID but may include only QoS information (namely, information for identifying a QoS filter). The Data Notification message may additionally include specific information about the downlink data. By using the additional information, the I-SMF or the V-SMF may also include the corresponding information in a message requesting a forwarding tunnel. Receiving the message, the SMF may determine whether the corresponding data may be transmitted through another access according to the N4 rule transmitted to the anchor UPF and when the corresponding data is not transmitted through another access, may reject setting up of the forwarding tunnel. This operation may prevent a forwarding tunnel from being unnecessarily set up for data not transmitted through another access. Also, when a GBR QoS flow is moved from one access to the other access, the SMF may usually perform a GBR QoS flow setup procedure only after receiving, from the anchor UPF, an indication notifying that data has to be transmitted through the other access. However, when a forwarding tunnel is requested, instead of waiting for an indication of the anchor UPF, the SMF may immediately perform setting up of the GBR QoS flow through the other access based on the information transmitted from the I-SMF or the V-SMF.

If a Multipath Transmission Control Protocol (MPTCP) is used, a different IP address (specifically, link-specific IP address) is used for each access; therefore, the anchor UPF may change the address included in the header within the data received through the forwarding tunnel again to a different IP address (specifically, link-specific IP address) of other access. Or, since independent re-transmission is allowed for the case of the MPCTP, a forwarding tunnel may not be made. In this case, since data is retransmitted based on the MPTCP, packet loss does not occur, and no additional procedure is required.

Generation of a forwarding tunnel may be performed differently according to the ATSSS steering mode or QoS flow. For example, when low latency is needed, the steering mode may be used as “Smallest Delay”. In this case, based on the steering mode and information on the corresponding QoS flow, the SMF may perform determination. In other words, the SMF does not determine that the forwarding tunnel is generated to transmit data up to the anchor UPF but determines that a tunnel is generated by the UPF (or a base station) to move the data directly toward 3GPP access.

Meanwhile, to prevent data loss, the SMF or the UPF should be able to determine whether data transmission is possible through specific access by using the first or the third method. Through this determination, the SMF or the UPF may not transmit data any longer or may transmit data again through the corresponding access.

According to the second method, an advantage is obtained that since a forwarding tunnel is generated, packet loss does not occur. However, signaling occurs to generate a forwarding tunnel, and downlink data already transmitted downward has to be transmitted again up to the anchor UPF.

II-3. Third Method of the Second Disclosure: SMF Subscribes to the Service of AMF Providing an Event (for Example, Move Event)

The third method proposes that the SMF subscribes to a service of the AMF providing a mobility event. When an MA PDU session is generated, the SMF performs subscription to the AMF for two events of Connectivity state changes (namely, change between the CM-IDLE state and the CM-CONNECTED state) and reachability state change of the UE. Then, when the UE changes to the IDLE state or the CONNECTED state or moves to a non-allowed area or an allowed area, the AMF transmits an event notification message to the SMF. For example, when the UE moves from an allowed area to a non-allowed area, the AMF may notify the SMF that the UE is reachable only for regulatory prioritized services. Therefore, the SMF may know that the UE has entered a non-allowed area. Based on this information, the SMF again provides the UPF with the corresponding information. Also, when the UE enters a non-allowed area and the UE is in the IDLE state on non-3GPP access, the UPF may not transmit data even through the non-3GPP access.

The event service subscription proposed by the third method is advantageous since improvement of the UE's operation is not required. However, in the case of HR-type roaming, an agreement is needed among service providers, which is a disadvantage that the third method may not be readily implemented.

When the third method is applied, loss of downlink data due to the ATSSS may be minimized. Through this feature, service continuity may be guaranteed.

II-4. Implementation Example of the Second Disclosure

In what follows, an example of improving the 3GPP standard according to each of the first to the third method of the second disclosure of the present disclosure and/or a combination of thereof will be described.

The reasons for improving the standard are as follows.

If an MA PDU session has been generated due to HR-type roaming and the UE is in the CM-IDLE state on non-3GPP access, part of packets may be lost. Specifically, the aforementioned case may be described as follows. In the case of HR-type roaming, since the H-UPF shares a downlink tunnel with the V-UPF, the H-UPF transmits downlink traffic through non-3GPP access. However, since the UE is in the IDLE state as the UE is located outside coverage of non-3GPP access, the traffic is not transmitted but to be discarded.

In general, if the UE is located outside coverage of non-3GPP access, the aforementioned problem may not occur if an indication notifying of unavailability is transmitted.

However, a similar problem may also occur in the following scenario:
The case where an additional UPF (for example, I-UPF) is added together with I-SMF or added alone without the I-SMF, and
The case where the UE is located in a non-allowed area on 3GPP access or the UE is in the CM-IDLE state on non-3GPP access.

As a result, for a non-roaming situation or LBO-type roaming, packet loss is unavoidable.

To solve the problem above, the following options may be considered.

Option 1: The SMF performs subscription to an event service and, if an event is received, transmits the received event to the UPF.

Option 2: If the UE is located in a non-allowed area, the UE transmits a report notifying of unavailability.

Option 3: A forwarding tunnel is set up in conjunction with the anchor UPF.

Different from a conventional event forwarding scheme, since an event has to be transmitted to the H-SMF through the V-SMF in the HR-type roaming situation, the operation requires to be improved. Moreover, the SMF has to transmit the event to the UPF through N4 signaling.

The option 2, to notify of the status of an access network, namely, availability or unavailability, requires the operation of the UE to be improved.

In the case of the option 3, if activation of the user plane fails, the SMF has to set up a forwarding tunnel in conjunction with the anchor UPF, and the anchor UPF has to transmit traffic through another access. The SMF has to transmit part of information to the UPF to prevent the UPF from transmitting traffic through the same access. In the case of HR-type roaming, since a forwarding tunnel has to be set up between two PLMNs, a roaming agreement is needed among service providers.

Although packet loss is not completely prevented only by the UE's notifying of unavailability of access, the network is enabled to switch a routing path very quickly, which makes the options 1 to 3 deemed to be effective.

In conclusion, the method, which makes the UE transmit a report notifying of unavailability of access when the UE enters a non-allowed area and makes the UE transmit a report notifying of availability of access when the UE enters an allowed area, may be considered to be an effective solution to prevent packet loss.

II-4-1. Example of the First Implementation

Suppose that after an MA PDU session is established,

user plane resources are deactivated on one of accesses between 3GPP access and non-3GPP access for the MA PDU session.

If the network attempts to reactivate the user plane on at least one access for the MA PDU session, the network has to perform a service request procedure on the access. If the reactivation fails, the SMF has to notify the UPF of the failure. Then the UPF may determine that the access is unavailable.

When the SMF transmits a Data Notification message or user plane resources are activated on the access, how the UPF determines whether the access has become available or not may be implemented in various ways.

Operation for transmitting a report notifying of availability and/or unavailability of access

When Measurement Assistance Information (MAI) is provided, the UE may perform the following operation to transmit a report notifying of availability and/or unavailability of access.
When the UE enters a non-allowed area, the UE may transmit a report notifying of unavailability of access.
When the UE enters an allowed area, the UE may transmit a report notifying of availability of access.

If the UE determines to transmit a report notifying of availability and/or unavailability of access,
The UE generates a PMF-access report including an indication notifying of availability and/or unavailability of access and information on the corresponding access type.
The UE transmits the PMF-access report to the UPF through the user plane.

The UPF transmits a response to reception of the PMF-access report.

II-4-2. Example of the Second Implementation: Adding/Reactivating/Deactivating of User Plane Resources

(a) When the UE has established an MA PDU session but user plane resources are not set up on one of accesses for the MA PDU session,
If the UE wants to add user plane resources on the access, the UE starts a PDU Session Establishment procedure on the access. To this end, the UE transmits an UL NAS Transport message. The UL NAS Transport message may include an indication indicating “MA PDU Request” and the same PDU session ID as that of an existing MA PDU session.
The UE receives a PDU Session Establishment Accept message. The PDU Session Establishment Accept message may include an ATSSS rule updated by the MA PDU session.
Meanwhile, if the SMF receives the PDU Session Establishment Request message through the access and the SMF already has SM context for the access, the SMF does not release the existing SM context but re-activates user plane resources on the access and transmits the PDU Session Establishment Accept message to the UE.

(b) If, although the UE has established an MA PDU session, the user plane resources are in the inactive state on one of the accesses (namely, when the UE is in the CM-IDLE state on the access),
If the UE wants to re-activate user plane resources on the access, the UE may initiate a registration procedure or a service request procedure through the access.
If a network node wants to re-activate the user plane resources on the 3GPP access or the non-3GPP access for the MA PDU session, the network node may initiate the service request procedure. If the UPF receives a failure indication, the UPF may determines that the corresponding access is unavailable and may discard buffered packets.

II-5. Fourth Method of the Second Disclosure: UPF Checks Availability of Access

The fourth method of the second disclosure makes the anchor UPF performing traffic control directly check availability of specific access before transmitting data through the corresponding access. However, if it is determined that the corresponding access is unavailable, the UPF may transmit the data through the other access according to the N4 rule received from the SMF and/or a traffic control rule. To check availability of specific access, the anchor UPF generates a special user plane packet (namely, a special packet for the checking) and transmits the packet to the UE through the access that the anchor UPF wants to check. This operation may be performed through the PMF. In other words, the special packet for the checking may be transmitted through a measurement message or transmitted through a new message. The UE transmits a response to the special packet through the user plane. At this time, the UE determine whether data transmission is actually possible through the corresponding access and transmits a response only when it is determined so. At this time, the message transmitted by the UE may be a new message. Or, the message transmitted by the UE may be a report message notifying of availability and/or unavailability. In other words, a report notifying of availability may be transmitted if data transmission is possible through the corresponding access. However, if data transmission is not possible, a report notifying of unavailability may be transmitted. At this time, the UE may transmit a report notifying of availability through the same access but transmit a report notifying of unavailability through access different from the access through which a request from the network has been received. Even when a report is transmitted through different access, the anchor UPF may check availability. If both accesses are unavailable, the anchor UPF packet may be discarded.

If it is found that data is currently being transmitted through the corresponding access, the corresponding access may be determined to be available, and data may be transmitted immediately without additional checking.

As described above, if the PMF message is used, an advantage is obtained that portions to be improved may be reduced throughout the system. Although the first method of the second disclosure may allow some amount of packet loss, since the anchor UPF according to the fourth method checks availability of access before transmitting data, an advantage is obtained that loss of data packets is minimized.

V. Summary of Disclosures of the Present Disclosure

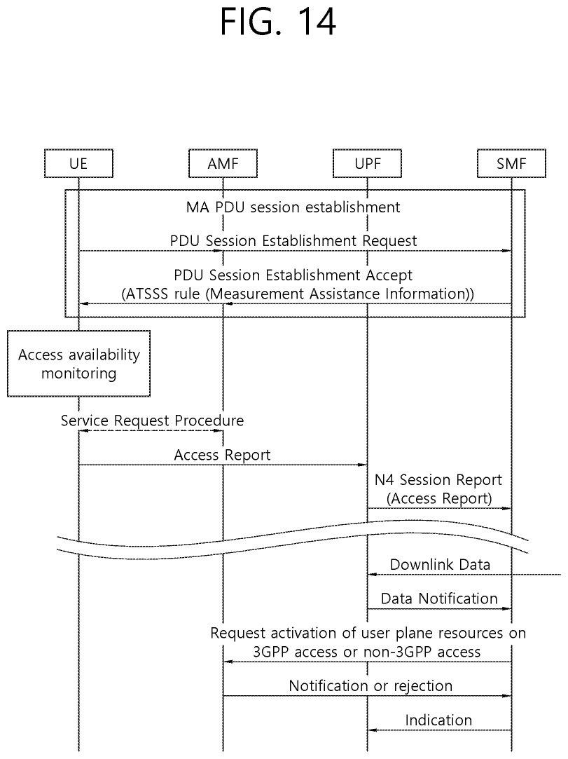

FIG. 14 summarizes disclosures of the present disclosure.

Referring to FIG. 14, first, the UE transmits a PDU Session Establishment Request message to the AMF to establish an MA PDU session. As described with reference to FIGS. 6a and 6b, the PDU Session Establishment Request message may be transmitted by being included in the N1 SM information within a NAS message. The AMF transmits the PDU Session Establishment Request message to the SMF. At this time, as shown in FIG. 11, the PDU Session Establishment Request message may be transmitted by being included in the Nsmf_PDUSession_CreateSMContext Request message.

The SMF transmits a PDU Session Establishment Accept message to the AMF. As shown in FIG. 11, the PDU Session Establishment Accept message may be transmitted by being included in the Namf_Communication_N1N2MessageTransfer message. The ATSSS rule information may include measurement assistance information. The measurement assistance information may include a configuration that makes the UE to report on whether specific access is in the available state and/or unavailable state.

The AMF transmits the PDU Session Establishment Accept message to the UE.

By doing so, an MA PDU session is established on 3GPP access and non-3GPP access.

The UE monitors access availability based on measurement assistance information within the PDU Session Establishment Accept message. In other words, the UE monitors whether one of the 3GPP access and the non-3GPP access becomes available or unavailable. Specifically, the UE monitors the availability or the unavailability based on one or more of information on the strength of a radio signal from one of the 3GPP access and the non-3GPP access; and information received from the network. The information received from the network may include service area restriction and restricted area information.

For example, when 3GPP access is available but non-3GPP access becomes unavailable, the UE generates an access report message to transmit a report on the access availability. The report message may include information indicating whether particular access is unavailable or available. The UE transmits the generated report message to the UPF through 3GPP access. At this time, if the UE is in the CM-IDLE state on the 3GPP access through which the report message is to be transmitted, the UE may transmit a service request message to the AMF to perform a service request procedure.

In another example, when non-3GPP access is available but 3GPP access becomes unavailable, and when the UE is in the CM-IDLE state on the available non-3GPP access, or when the MA PDU session is in the inactive state, the UE may transmit a service request message to the AMF through the non-3GPP access to transmit the report message. Afterwards, the UE may transmit the report message.

Meanwhile, if the UPF receives downlink data to be transmitted to the UE, the UPF transmits a data notification message to the SMF.

When the SMF requests activation of user plane resources on the 3GPP access based on the data notification, the AMF determines whether the UE is in the reachable state on the 3GPP access. If it is determined that the UE is not in the reachable state on the 3GPP access, the AMF notifies the SMF that the UE is not in the reachable state. The SMF notifies the UPF that radio plane resources on the 3GPP access are unavailable.

Alternatively, based on the data notification, if the SMF requests activation of user plane resources on the non-3GPP access, the AMF determines whether the UE is in the reachable state on the non-3GPP access. If it is determined that the UE is not in the reachable state on the non-3GPP access (namely, when the UE is determined to be in the CM-IDLE state on the non-3GPP access), the AMF rejects the request of the SMF. The SMF notifies the UPF that radio plane resources on the non-3GPP access are unavailable.

<A General Example to which Disclosures of the Present Disclosure May be Applied>

A part of disclosures of the present disclosure as described above may be summarized as follows.

In what follows, an apparatus to which disclosures of the present disclosure may be applied will be described.

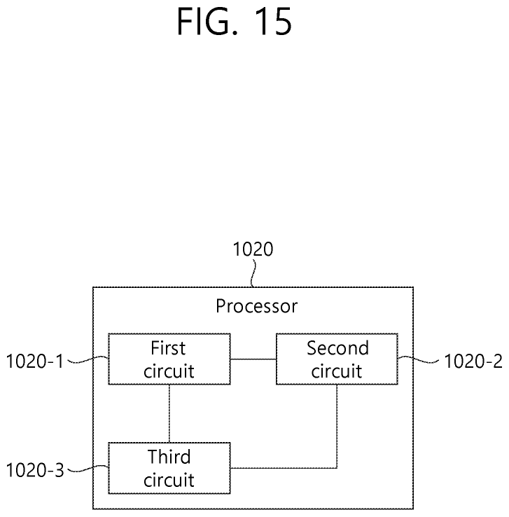

FIG. 15 illustrates a block diagram of a processor in which the present disclosure is implemented.

As may be seen from FIG. 15, the processor 1020 in which the present disclosure is implemented may include a plurality of circuitry to implement functions, procedures and/or methods described in the present disclosure. For example, the processor 1020 may include a first circuit 1020-1, a second circuit 1020-2, and a third circuit 1020-3. Also, although not shown in the figure, the processor 1020 may include more circuits. Each circuit may include a plurality of transistors.

The processor 1020 may be called Application-Specific Integrated Circuit (ASIC) or Application Processor (AP) and may include at least one of a Digital Signal Processor (DSP), a Central Processing Unit (CPU), and a Graphics Processing Unit (GPU).

The processor may be included in the UE.

The first circuit 1020-1 of the processor may perform receiving measurement assistance information from a Session Management Function (SMF) node. The measurement assistance information may relate to the MA PDU session over 3rd Generation Partnership Project (3GPP) access and non-3GPP access. The second circuit 1020-2 of the processor may perform transmitting a report based on the measurement assistance information. The report may include information on availability or unavailability of at least one of the 3GPP access and the non-3GPP access. The report may be transmitted to a User Plane Function (UPF) node via a user plane.

The measurement assistance information may be received by being included within a PDU Session Establishment Accept message.

The third circuit 1020-3 of the processor may detect availability of unavailability of at least one of the 3GPP access and the non-3GPP access.

The report may be transmitted to the SMF node from the UPF node.

Although not shown in the figure, the processor may further include a fourth circuit, and the fourth circuit may transmit a service request message via the non-3GPP access based on (i) that the report needs to be transmitted and (ii) that the apparatus is in the idle state on the non-3GPP access.

The processor may also be included in the SMF node. In this case, the SMF node may comprise the processor; and at least one memory capable of storing instructions and being connected electrically to the at least one processor operably. An operation, performed when the instructions are executed by the at least one processor, may include transmitting measurement assistance information (MAI) to a UE. The MAI may be related to the MA PDU session on 3rd Generation Partnership Project (3GPP) access and non-3GPP access. The operation may include receiving a report on the UE from a User Plane Function (UPF) node. The report may include information on availability or unavailability of at least one of the 3GPP access and the non-3GPP access within the MA PDU session. The operation may include performing traffic steering for the MA PDU session based on the received report.

The processor may be included in the SMF node. In this case, the SMF node may comprise the processor; and at least one memory capable of storing instructions and being connected electrically to the at least one processor operably. An operation, performed when the instructions are executed by the at least one processor, may include, when a user plane resource on at least one of 3rd Generation Partnership Project (3GPP) access and non-3GPP access to which an MA PDU session has been established for a UE is in the inactive state, transmitting a first message for requesting re-activation of the user plane resource on the at least one access; receiving a second message from an Access and Mobility Management Function (AMF) node; and when the second message is used for notifying that the UE is unreachable on the at least one access, transmitting a third message including information indicating that the UE is unreachable on the at least one access.

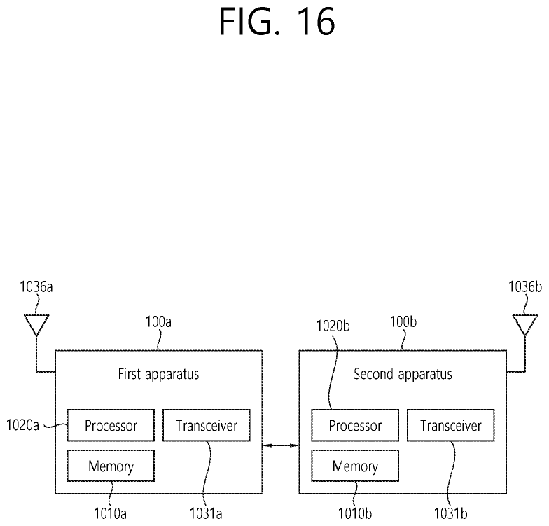

FIG. 16 shows a wireless communication system according to an embodiment.

Referring to FIG. 16, a wireless communication system may include a first device 100a and a second device 100b.

The first device 100a may be a terminal as described in the present disclosure. Or, the first device 100a may be a base station, a network node, a transmitting terminal, a receiving terminal, a wireless device, a wireless communication device, a vehicle, a vehicle equipped with self-driving capability, a connected car, a drone (or an unmanned aerial vehicle (UAV)), an artificial intelligence (AI) module, a robot, an augmented reality (AR) device, a virtual reality (VR) device, a mixed reality (MR) device, a hologram device, a public safety device, an MTC device, an IoT device, a medical device, a FinTech device (or a financial device), a security device, a climate/environment device, a device related to a 5G service, or a device related to a field of the 4th industrial revolution.

The second device 100b may be a network node (e.g., AMF or MME) as described in the present disclosure. The second device 100b may be a base station, a network node, a transmitting terminal, a receiving terminal, a wireless device, a wireless communication device, a vehicle, a vehicle equipped with self-driving capability, a connected car, a drone (or an unmanned aerial vehicle (UAV)), an artificial intelligence (AI) module, a robot, an augmented reality (AR) device, a virtual reality (VR) device, a mixed reality (MR) device, a hologram device, a public safety device, an MTC device, an IoT device, a medical device, a FinTech device (or a financial device), a security device, a climate/environment device, a device related to a 5G service, or a device related to a field of the 4th industrial revolution.

For example, a terminal may include a mobile phone, a smart phone, a laptop computer, a digital broadcasting terminal, a personal digital assistants (PDA), a portable multimedia player (PMP), a navigation, a slate PC, a table PC, an ultrabook, a wearable device (e.g., a smartwatch, a smart glass, a head mounted display (HMD)), or the like. For example, the HMD may be a display device worn on a head. For example, the HMD may be used to implement VR, AR, or MR.

For example, the drone may be an unmanned aerial vehicle which flies by using a radio control signal. For example, the VR device may include a device for realizing an object, background, or the like of a virtual world. For example, the AR device may include a device for realizing an object or background of a virtual world by connecting with an object or background or the like of a real world. For example, the MR device may include a device for realizing an object or background of a virtual world by merging an object, background, or the like of a real world. For example, the hologram device may include a device for recording and reproducing stereoscopic information to realize a 360-degree stereoscopic image, by utilizing light interference which occurs when two laser beams called holography are met. For example, the public safety device may include an image relay device or an image device or the like which can be worn on a user's body. For example, the MTC device and the IoT device may be devices not requiring direct human intervention or manipulation. For example, the MTC device and the IoT device may include a smart meter, a bending machine, a thermometer, a smart bulb, a door lock, or various sensors. For example, the medical device may be a device used for diagnosing, curing, alleviating, treating, or preventing a disease. For example, the medial device may be a device used for diagnosing, curing, alleviating or ameliorating an injury or disorder. For example, the medial device may be a device used for inspecting, replacing, or modifying a structure or function. For example, the medical device may be a device used for controlling pregnancy. For example, the medical device may include a diagnostic device, a surgical device, a (in vitro) diagnostic device, a hearing aid, or a treatment device. For example, the security device may be a device installed to prevent potential hazards and maintain security. For example, the security device may be a camera, a CCTV, a recorder, or a black box. For example, the Fin-Tech device may be a device capable of providing financial services such as mobile payment. For example, the Fin-tech device may include a payment device or a point of sales (POS). For example, the climate/environmental device may include a device for monitoring or predicting climates/environments.

The first device 100a may include at least one processor such as a processor 1020a, at least one memory such as a memory 1010a, and at least one transceiver such as a transceiver 1031a. The processor 1020a may perform the aforementioned functions, procedures, and/or methods. The processor 1020a may perform one or more protocols. For example, the processor 1020a may perform one or more layers of a radio interface protocol. The memory 1010a may be coupled to the processor 1020a, and may store various types of information and/or commands. The transceiver 1031a may be coupled to the processor 1020a, and may be controlled to transmit/receive a radio signal.

The second device 100b may include at least one processor such as a processor 1020b, at least one memory such as a memory 1010b, and at least one transceiver such as a transceiver 1031b. The processor 1020b may perform the aforementioned functions, procedures, and/or methods. The processor 1020b may perform one or more protocols. For example, the processor 1020b may perform one or more layers of a radio interface protocol. The memory 1010b may be coupled to the processor 1020b, and may store various types of information and/or commands. The transceiver 1031b may be coupled to the processor 1020b, and may be controlled to transmit/receive a radio signal.

The memory 1010a and/or the memory 1010b may be connected internally or externally to the processor 1020a and/or the processor 1020b, respectively, or may be connected to other processors through various techniques such as wired or wireless connections.

The first device 100a and/or the second device 100b may have one or more antennas. For example, an antenna 1036a and/or an antenna 1036b may be configured to transmit/receive a radio signal.

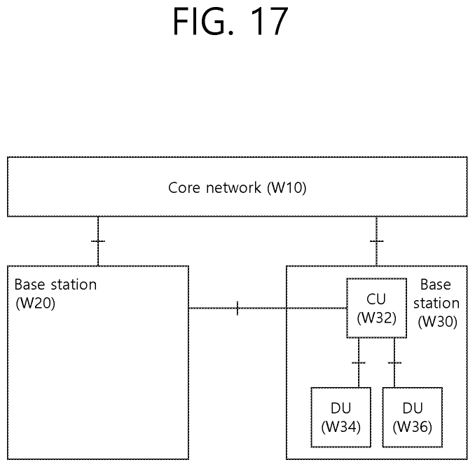

FIG. 17 is a block diagram of a network node according to an embodiment.

In particular, FIG. 17 illustrates in detail the case where a base station is divided into a Central Unit (CU) and a Distributed Unit (DU).

Referring to FIG. 17, base stations W20 and W30 may be connected to a core network W10, and the base station W30 may be connected to the neighboring base station W20. For example, an interface between the base stations W20 and W30 and the core network W10 may be referred to as NG, and an interface between the base station W30 and the neighboring base station W20 may be referred to as Xn.

The base station W30 may be divided into a CU W32 and DUs W34 and W36. That is, the base station W30 may be managed by being separated in a layered manner. The CU W32 may be connected to one or more DUs W34 and W36. For example, an interface between the CU W32 and the DUs W34 and W36 may be referred to as F1. The CU W32 may perform a function of higher layers of the base station, and the DUs W34 and W36 may perform a function of lower layers of the base station. For example, the CU W32 may be a logical node for hosting radio resource control (RRC), service data adaptation protocol (SDAP), and packet data convergence protocol (PDCP) layers of the base station (e.g., gNB), and the DUs W34 and W36 may be a logical node for hosting radio link control (RLC), media access control (MAC), and physical (PHY) layers of the base station. Alternatively, the CU W32 may be a logical node for hosting RRC and PDCP layers of the base station (e.g., en-gNB).

Operations of the DUs W34 and W36 may be partially controlled by the CU W32. One DU W34 or W36 may support one or more cells. One cell may be supported only by one DU W34 or W36. One DU W34 or W36 may be connected to one CU W32, and one DU W34 or W36 may be connected to a plurality of CUs by proper implementation.

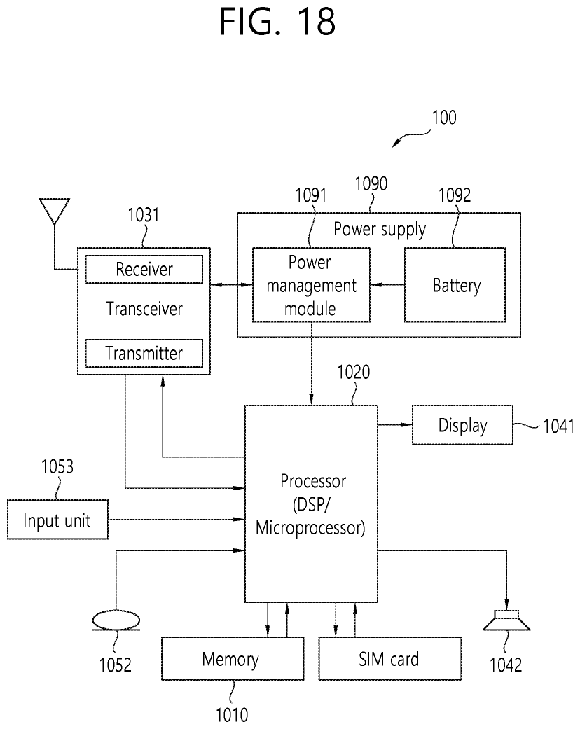

FIG. 18 is a block diagram showing a structure of a terminal according to an embodiment.

In particular, FIG. 18 shows an example of the terminal of FIG. 16 in greater detail.

A terminal includes a memory 1010, a processor 1020, a transceiver 1031, a power management module 1091, a battery 1092, a display 1041, an input unit 1053, a speaker 1042, a microphone 1052, a subscriber identification module (SIM) card, and one or more antennas.

The processor 1020 may be configured to implement the proposed functions, procedures, and/or methods described in the present specification. Layers of a radio interface protocol may be implemented in the processor 1020. The processor 1020 may include application-specific integrated circuits (ASICs), other chipsets, logic circuits, and/or data processing units. The processor 1020 may be an application processor (AP). The processor 1020 may include at least one of a digital signal processor (DSP), a central processing unit (CPU), a graphics processing unit (GPS), and a modulator and demodulator (modem). An example of the processor 1020 may include an SNAPDRAGON™ series processor manufactured by Qualcomm®, an EXYNOS™ series processor manufactured by Samsung®, an A series processor manufactured by Apple®, a HELIO™ series processor manufactured by MediaTek®, an ATOM™ series processor manufactured by INTEL®, or a corresponding next-generation processor.

The power management module 1091 manages power for the processor 1020 and/or the transceiver 1031. The battery 1092 supplies power to the power management module 1091. The display 1041 outputs a result processed by the processor 1020. The input unit 1053 receives an input to be used by the processor 1020. The input unit 1053 may be displayed on the display 1041. The SIM card is an integrated circuit used to safely store an international mobile subscriber identity (IMSI) used to identify and authenticate a subscriber and a key related thereto in a portable phone and a portable phone device such as a computer. Contacts information may be stored in many SIM cards.

The memory 1010 is operatively coupled to the processor 1020, and stores a variety of information for operating the processor 1020. The memory 1010 may include a read-only memory (ROM), a random access memory (RAM), a flash memory, a memory card, a storage medium, and/or other equivalent storage devices. When the embodiment is implemented in software, the techniques explained in the present specification can be implemented with a module (i.e., procedure, function, etc.) for performing the functions explained in the present specification. The module may be stored in the memory 1010 and may be performed by the processor 1020. The memory 1010 may be implemented inside the processor 1020. Alternatively, the memory 1010 may be implemented outside the processor 1020, and may be coupled to the processor 1020 in a communicable manner by using various well-known means.

The transceiver 1031 is operatively coupled to the processor 1020, and transmits and/or receives a radio signal. The transceiver 1031 includes a transmitter and a receiver. The transceiver 1031 may include a baseband signal for processing a radio frequency signal. The transceiver controls one or more antennas to transmit and/or receive a radio signal. In order to initiate communication, the processor 1020 transfers command information to the transceiver 1031, for example, to transmit a radio signal constituting voice communication data. The antenna serves to transmit and receive a radio signal. When the radio signal is received, the transceiver 1031 may transfer a signal to be processed by the processor 1020, and may convert the signal into a baseband signal. The processed signal may be converted into audible or readable information which is output through the speaker 1042.

The speaker 1042 outputs a result related to a sound processed by the processor 1020. The microphone 1052 receives a sound-related input to be used by the processor 1020.

A user presses (or touches) a button of the input unit 1053 or drives voice (activates voice) by using the microphone 1052 to input command information such as a phone number or the like. The processor 1020 receives the command information, and performs a proper function such as calling the phone number or the like. Operational data may be extracted from the SIM card or the memory 1010. In addition, the processor 1020 may display command information or operational information on the display 1041 for user's recognition and convenience.

<Scenario to which the Present Disclosure May be Applied>

In what follows, scenarios to which the disclosures above may be applied will be described.

According to the present disclosure, an always-on PDU session for URLLC exhibiting a feature of low latency may be applied to the following 5G scenarios including artificial intelligence, robot, autonomous driving, and extended reality.

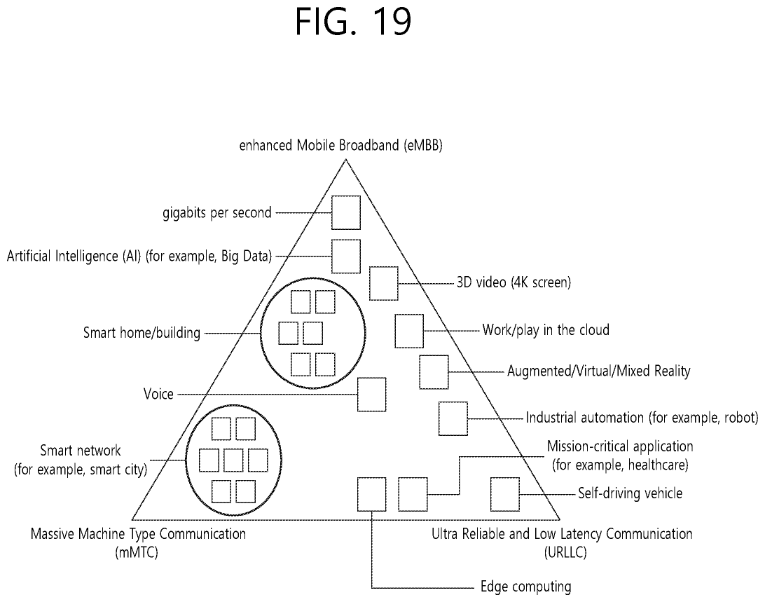

FIG. 19 illustrates one example of a 5G use case scenario.

The 5G use case scenario shown in FIG. 19 is only an example, and technical characteristics of the present disclosure may also be applied to other 5G use case scenarios.

Referring to FIG. 19, three primary requirement areas of the 5G include (1) the enhanced Mobile Broadband (eMBB) area, (2) the massive Machine Type Communication (MTC) area, and (3) the Ultra-Reliable and Low Latency Communication (URLLC) area. Part of the use cases may require a plurality of areas for the purpose of optimization while other use cases may focus only on a single key performance indicator (KPI). The 5G supports the various use case scenarios in a flexible and reliable manner.

The eMBB focuses on overall improvement of a data rate, latency, user density, mobile broadband access capacity, and coverage. The eMBB aims at a throughput of about 10 Gbps. The eMBB allows to surpass basic mobile Internet access, and covers sufficient interactive tasks, media in a cloud or augmented reality, and entertainment application. Data is one of the core engine for 5G, and it seems that a dedicated voice service can be seen for the first time in the 5G era. In the 5G, it is expected that voice will be simply processed with an application program by using a data connection provided by a communication system. A main reason of an increased traffic amount is an increase in a content size and an increase in the number of applications requiring a high data transfer rate. A streaming service (audio and video), interactive video, and mobile Internet connectivity will be more widely used as more devices are connected to the Internet. These many applications require always-on connectivity to push real-time information and notifications to a user. There is a rapid increase in cloud storage and applications in a mobile communication platform, which is applicable to both work and entertainment. The cloud storage is a special example of driving an increase in an uplink data transfer rate. The 5G is also used for a remote task on the cloud, and requires much lower end-to-end latency to maintain excellent user experience when a tactile interface is used. Taking entertainment for example, cloud games and video streaming are another key element requiring improvement in mobile broadband capability. The entertainment is essential in a smartphone and a tablet anywhere, including a high mobility environment such as a train, a car, and an airplane. Another usage example is augmented reality and information retrieval for entertainment. Herein, the augmented reality requires very low latency and an instantaneous data amount.

The mMTC is designed to enable communication between a plenty of low-cost devices driven by batteries and is intended to support an application such as smart metering, logistics, and field and body sensors. The mMTC aims at about 10-year-lifespan batteries and/or about million devices per square kilometer (1 km2). The mMTC may configure a sensor network by seamlessly connecting an embedded sensor in all sectors, and is one of the most expected 5G usage examples. Potentially, it is predicted that the number of IoT devices will reach 20.4 billion by 2020. A smart network utilizing industrial IoT is one of areas where the 5G plays a key role in enabling smart cities, asset tracking, smart utilities, agriculture, and security infrastructures.

The URLLC allows a device and a machine to communicate with very high reliability, very low latency, and high availability, and thus is identical to communication and control between self-driving vehicles, industrial control, factory automation, mission-critical applications such as remote operations and healthcare, smart grids, and public safety applications. The URLLC aims at a latency of about 1 ms. The URLLC includes a new service which will change the industry through a link with high-reliability/ultra-low latency such as remote control and self-driving vehicles. A level of reliability and latency is essential for smart grid control, industrial automation, robotics, and drone control and adjustment.

Next, a plurality of usage examples included in the triangle of FIG. 13 will be described in greater detail.

In 5G, fiber-to-the-home (FTTH) and cable-based broadband (or DOCSIS) may be compensated as a means of providing a stream rated in the range from hundreds of megabits per second to gigabits per second. This fast speed may be required not only in virtual reality (VR) and augmented reality (AR) but also in transferring TV broadcasting in the resolution of at least 4 K (6K, 8K, or higher). VR and AR applications include almost immersive sports events. A specific application may require a special network configuration. For example, in case of the VR game, a game company may have to integrate a core server with an edge network server of an operator in order to minimize latency.

Automotive is expected to become an important new engine for 5G, together with many usages for mobile communications for vehicles. For example, entertainment for a passenger demands high capacity and high mobile broadband at the same time. This is because future users will continue to expect high-quality connectivity regardless of their locations and speeds. Another usage example of the automotive sector is an augmented reality dashboard. Through the augmented reality dashboard, a driver is able to identify an object, in the dark, shown above that the driver is seeing through a windshield. The augmented reality dashboard displays information to be reported to the deriver as to a distance and movement of an object in an overlapping manner. In the future, a radio module will enable communication between vehicles, information exchange between a vehicle and a supported infrastructure, and information exchange between an automotive and another connected device (e.g., a device carried by a pedestrian). The safety system guides an alternative course of action so that the driver can drive more safely, thereby decreasing a risk of accidents. A next step will be a remote control vehicle or a self-driving vehicle. This requires very reliable and very fast communication between different self-driving vehicles and/or between an automotive and an infrastructure. In the future, the self-driving vehicle will perform all driving activities, and the driver will focus only on erroneous traffic which cannot be identified by the vehicle itself. A technical requirement of the self-driving vehicle is ultra-low latency and ultra-high reliability so that traffic safety is increased to a level that cannot be achieved by humans.

A smart city and a smart home, referred to as a smart society, will be embedded in a high-density wireless sensor network as an example of a smart network. A distributed network of an intelligent sensor will identify a condition for cost and energy-efficient maintenance of a city or home. A similar configuration may be performed for each household. A temperature sensor, a window and heating controller, a burglar alarm, and home appliance are all wirelessly connected. Many of these sensors typically require a low data rate, low power, and low cost. For example, however, real-time HD video may be required in a specific-type device for surveillance.

Since consumption and distribution of energy, including heat or gas, are highly dispersed, automated control of a distributed sensor network is required. The smart grid interconnects these sensors by using digital information and communication techniques to collect information and act according to the information. This information may include acts of suppliers and consumers, allowing the smart grid to improve distribution of fuels such as electricity in an efficient, reliable, production sustainable, and automated manner. The smart grid may be regarded as another sensor network with low latency.

The health sector has many applications which can benefit from mobile communication. A communication system may support telemedicine which provides a clinical care in remote locations. This may help to reduce a barrier for a distance, and may improve access to a medical service which cannot be persistently used in a far rural area. This is also used to save lives in a critical care and an emergency situation. A wireless sensor network based on mobile communication may provide remote monitoring and sensors for parameters such as heart rates and blood pressure.

Wireless and mobile communications are becoming gradually important in an industrial application sector. Wiring is expensive in terms of installation and maintenance cost. Therefore, a possibility of replacing a cable with a wireless link that can be reconfigured is an attractive opportunity in many industrial sectors. However, to achieve this, wireless connectivity is required to operate with latency, reliability, and capacity similar to those of a cable, and to be managed in a simplified manner. Low latency and very low error probability are new requirements, which requires 5G connectivity.

Logistics and cargo tracking are an important usage example for mobile communication which enables inventory and package tracking anywhere by using a location-based information system. An example of using logistics and cargo tracking typically requires a low data rate, but requires wide range and reliable location information.

<Artificial Intelligence (AI)>

Artificial intelligence refers to a sector that studies artificial intelligence and a methodology for creating it. Machine learning refers to a sector that defines various problems dealt in an artificial intelligent sector and studies a methodology for solving the problems. The machine learning is also defined as an algorithm that improves performance of a task through a steady experience for a certain task.

The artificial neural network (ANN) is a model used for machine learning, which may mean a collection of models comprising artificial neurons (nodes) forming a network via connection of synapses and having a problem-solving capability. An artificial neural network may be defined by a connection pattern among neurons forming different layers, a learning process for updating model parameters, and an activation function for generating output values.

An artificial neural network may include an input layer, an output layer, and optionally, one or more hidden layers. Each layer have one or more neurons, and the artificial neural network may include synapses for connecting neurons with each other. In the artificial neural network, each neuron may output function values of activation functions from input signals input through synapses, weights, and biases.

Model parameters mean parameters determined through learning and include weights for synapse connections and biases of neurons. And hyper-parameters mean those parameters that have to be set up before the learning process in a machine learning algorithm, which include a learning rate, the number of repetitions, size of mini-batches, and an initialization function.

The purpose of learning in the artificial neural network may be considered to determine model parameters which minimize a loss function. The loss function may be used as an index for determining the optimal model parameters during a learning process of the artificial neural network.

Machine learning may be classified into supervised learning, unsupervised learning, and reinforced learning depending on the learning scheme.

Supervised learning is a method for training an artificial neural network when labels are given for learning data, where a label may mean an expected answer (or a result value) that the artificial neural network is expected to infer when the learning data is input to the artificial neural network. Unsupervised learning may mean a method for training an artificial neural network while labels for learning data are not given. Reinforcement learning may mean a learning method that trains an artificial neural network in such a way that an agent defined in a particular environment is forced to take an action or a sequence of actions that maximizes cumulative reward in each state.

Among artificial neural networks, machine learning implemented by a Deep Neural Network (DNN) including a plurality of hidden layers is called deep learning. Deep learning is considered to be a part of machine learning. In what follows, machine learning is used as a notion that includes deep learning.

<Robot>

A robot may mean a machine which automatically operates or processes a given task according to its own capability. In particular, a robot having a function of performing an operation by recognizing an environment and by autonomously making a decision may be referred to as an intelligent robot.

The robot may be classified for industrial, medical, household, and military purposes depending on the purpose or field of use.

The robot may include a driving unit having an actuator or a motor to perform various physical operations such as moving a robot joint. In addition, a movable robot may include a wheel, a brake, a propeller, and the like in the driving unit, thereby being able to driving on the ground or flying in the air through the driving unit.

<Self-Driving (Autonomous-Driving)>

Self-driving means an autonomous-driving technique, and a self-driving vehicle means a vehicle that travels without user's manipulation or with minimum user' manipulation.

For example, the self-driving may include all of a technique for maintaining a lane while driving, a technique for automatically controlling speed such as adaptive cruise control, a technique for automatically travelling along a predetermined route, and a technique for travelling by automatically setting a route when a destination is determined.

The vehicle may include all of a vehicle having only an internal combustion engine, a hybrid vehicle having an internal combustion engine and an electric motor together, and an electric vehicle having only an electric motor, and may include not only an automotive vehicle but also a train, a motorcycle, etc.

In this case, the self-driving vehicle may be regarded as a robot having an autonomous-driving function.

<eXtended Reality (XR)>

Extended reality collectively refers to virtual reality (VR), augmented reality (AR), and mixed reality (MR). A VR technique is a computer graphic technique providing real-world objects and backgrounds only as CG images. An AR technique a computer graphic technique providing virtual CG images together on real object images. An MR technique is a computer graphic technique providing virtual objects in the real world in a mixed and combined manner.

The MR technique is similar to the AR technology in a sense that a real object and a virtual object are shown together. However, the AR technology in which the virtual object is used as a complement to the real object differs from the MR technology in which the virtual object and the real object are used in an equal manner.

The XR technique may be applied to a head-mount display (HMD), a head-up display (HUD), a mobile phone, a tablet PC, a laptop, a desktop, TV, a digital signage, etc., and a device to which the XR technique is applied may be referred to as an XR device.

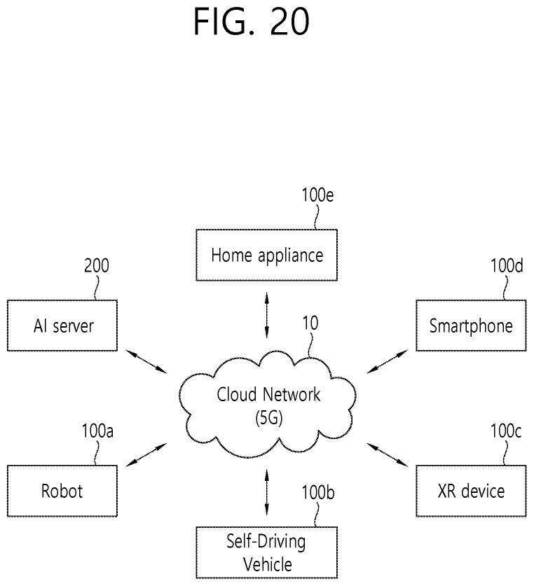

FIG. 20 shows an AI system 1 according to an embodiment.

Referring to FIG. 20, in the AI system 1, at least one of an AI server 200, a robot 100a, a self-driving vehicle 100b, an XR device 100c, a smart phone 100d, and a home appliance 100e is connected to a cloud network 10. Herein, the robot 100a, self-driving vehicle 100b, XR device 100c, smart phone 100d, or home appliance 100e to which the AI technique is applied may be referred to as AI devices 100a to 100e.

The cloud network 10 may mean a network which constructs part of a cloud computing infrastructure or which exists in the cloud computing infrastructure. Herein, the cloud network 10 may be configured by using a 3G network, a 4G or long term evolution (LTE) network, or a 5G network.

That is, each of the devices 100a to 100e and 200 constituting the AI system 1 may be connected to each other through the cloud network 10. In particular, the devices 100a to 100e and 200 may communicate with each other via a base station, but may communicate with each other directly without having to use the base station.

The AI server 200 may include a server which performs AI processing and a server which performs an operation for big data.

The AI server 200 may be connected to at least one of the AI devices constituting the AI system 1, that is, the robot 100a, the self-driving vehicle 100b, the XR device 100c, the smart phone 100d, and the home appliance 100e through the cloud network 10, and may assist at least part of AI processing of the connected AI devices 100a to 100e.

In this case, the AI server 200 may serve to learn an artificial neural network according to a machine learning algorithm on behalf of the AI devices 100a to 100e, and may directly store a learning model or transmit it to the AI devices 100a to 100e.

In this case, the AI server 200 may receive input data from the AI devices 100a to 100e, infer a result value for the input data received using the learning module, and generate a control command or a response based on the inferred result value to transmit it to the AI devices 100a to 100e.

Alternatively, the AI devices 100a to 100e may infer the result value for the input data by using a direct learning model and generate a control command and a response based on the inferred result value.

Hereinafter, various embodiments of the AI devices 100a to 100e to which the aforementioned techniques are applied will be described.

<AI+Robot>

The robot 100a may be implemented as a guide robot, a carrying robot, a cleaning robot, a wearable robot, an entertainment robot, a pet robot, an unmanned flying robot, etc., by applying the AI technique.

The robot 100a may include a robot control module for controlling an operation, and the robot control module may mean a software module or a chip implementing the software module as hardware.

The robot 100a may use sensor information acquired from various types of sensors to obtain status information of the robot 100a, to detect (recognize) a surrounding environment and an object, to generate map data, to determine a travel route and a driving plan, to determine a response for user interaction, or to determine an operation.

Herein, the robot 100a may use the sensor information acquired from at least one sensor among a lidar, a radar, and camera to determine a travel path and a driving plan.

The robot 100a may use a leaning model consisting of at least one artificial neural network to perform the aforementioned operations. For example, the robot 100a may use the leaning model to recognize a surrounding environment and an object, and may use the recognized surrounding environment information or object information to determine an operation. Herein, the leaning model may be learned directly from the robot 100a or learned from an external device such as the AI server 200 or the like.

In this case, the robot 100a may generate a result and perform an operation by directly using the learning model. However, it is also possible to perform an operation by transmitting sensor information to the external device such as the AI server 200 or the like and by receiving a result generated based thereon.

The robot 100a may determine the travel path and the driving plan by using at least one of map date, object information detected from sensor information, and object information acquired from an external device, and may control a driving unit so that the robot 100a travels according to the determined travel path and driving plan.

The map data may include object identification information on various objects arranged in a space in which the robot 100a moves. For example, the map data may include object identification information on stationary objects such as walls, doors, or the like and movable objects such as flowerpots, desks, or the like. In addition, the object identification information may include a name, a type, a distance, a location, or the like.

In addition, the robot 100a may control the driving unit on the basis of a user's control/interaction to travel or perform an operation. In this case, the robot 100a may acquire the intention information of an interaction based on a user's action or voice utterance, and may determine a response based on the acquired intention information to perform an operation.

<AI+Self-Driving>

By employing the AI technology, the self-driving vehicle 100b may be implemented as a mobile robot, unmanned ground vehicle, or unmanned aerial vehicle.

The self-driving vehicle 100b may include a self-driving module for controlling its self-driving function, where the self-driving control module may correspond to a software module or a chip which implements the software module in the form of a hardware device. The self-driving control module may be installed inside the self-driving vehicle 100b as a constituting element thereof or may be installed outside the self-driving vehicle 100b as a separate hardware component.

The self-driving vehicle 100b may obtain status information of the self-driving vehicle 100b, detect (recognize) the surroundings and objects, generate map data, determine a travel path and navigation plan, or determine motion by using sensor information obtained from various types of sensors.

Like the robot 100a, the self-driving vehicle 100b may use sensor information obtained from at least one or more sensors among lidar, radar, and camera to determine a travel path and navigation plan.

In particular, the self-driving vehicle 100b may recognize an occluded area or an area extending over a predetermined distance or objects located across the area by collecting sensor information from external devices or receive recognized information directly from the external devices.

The self-driving vehicle 100b may perform the operations above by using a learning model built on at least one or more artificial neural networks. For example, the self-driving vehicle 100b may recognize the surroundings and objects by using the learning model and determine its navigation route by using the recognized surroundings or object information. Here, the learning model may be the one trained by the self-driving vehicle 100b itself or trained by an external device such as the AI server 200.

At this time, the self-driving vehicle 100b may perform the operation by generating a result by employing the learning model directly but also perform the operation by transmitting sensor information to an external device such as the AI server 200 and receiving a result generated accordingly.

The self-driving vehicle 100b may determine a travel path and a navigation plan by using at least one or more of object information detected from the map data and sensor information or object information obtained from an external device and navigate according to the determined travel path and the navigation plan by controlling its driving platform.

Map data may include object identification information about various objects disposed in the space (for example, road) in which the self-driving vehicle 100b navigates. For example, the map data may include object identification information about static objects such as streetlights, rocks and buildings and movable objects such as vehicles and pedestrians. And the object identification information may include the name, type, distance, location, and so on.

Also, the self-driving vehicle 100b may perform the operation or navigate the space by controlling its driving platform based on the control/interaction of the user. At this time, the self-driving vehicle 100b may obtain intention information of the interaction due to the user's motion or voice command and perform an operation by determining a response based on the obtained intention information.

<AI+XR>

By employing the AI technology, the XR device 100c may be implemented as a Head-Mounted Display (HMD), a Head-Up Display (HUD) installed at the vehicle, TV, a mobile phone, a smartphone, a computer, a wearable device, a home appliance, a digital signage, a vehicle, a robot with a fixed platform, or a mobile robot.

The XR device 100c may obtain information about the surroundings or physical objects by generating position and attribute data about 3D points by analyzing 3D point cloud or image data acquired from various sensors or external devices and output objects in the form of XR objects by rendering the objects for display.

The XR device 100c may perform the operations above by using a learning model built on at least one or more artificial neural networks. For example, the XR device 100c may recognize physical objects from 3D point cloud or image data by using the learning model and provide information corresponding to the recognized physical objects. Here, the learning model may be the one trained by the XR device 100c itself or trained by an external device such as the AI server 200.

At this time, the XR device 100c may perform the operation by generating a result by employing the learning model directly but also perform the operation by transmitting sensor information to an external device such as the AI server 200 and receiving a result generated accordingly.

<AI+Robot+Self-Driving>

By employing the AI and self-driving technologies, the robot 100a may be implemented as a guide robot, a transport robot, a cleaning robot, a wearable robot, an entertainment robot, a pet robot, or an unmanned flying robot.

The robot 100a employing the AI and self-driving technologies may correspond to a robot itself having a self-driving function or a robot 100a interacting with the self-driving vehicle 100b.

The robot 100a having the self-driving function may correspond collectively to the devices which may move autonomously along a given path without control of the user or which may move by determining its path autonomously.

The robot 100a and the self-driving vehicle 100b having the self-driving function may use a common sensing method to determine one or more of the travel path or navigation plan. For example, the robot 100a and the self-driving vehicle 100b having the self-driving function may determine one or more of the travel path or navigation plan by using the information sensed through lidar, radar, and camera.

The robot 100a interacting with the self-driving vehicle 100b, which exists separately from the self-driving vehicle 100b, may be associated with the self-driving function inside or outside the self-driving vehicle 100b or perform an operation associated with the user riding the self-driving vehicle 100b.

At this time, the robot 100a interacting with the self-driving vehicle 100b may obtain sensor information in place of the self-driving vehicle 100b and provide the sensed information to the self-driving vehicle 100b; or may control or assist the self-driving function of the self-driving vehicle 100b by obtaining sensor information, generating information of the surroundings or object information, and providing the generated information to the self-driving vehicle 100b.

Also, the robot 100a interacting with the self-driving vehicle 100b may control the function of the self-driving vehicle 100b by monitoring the user riding the self-driving vehicle 100b or through interaction with the user. For example, if it is determined that the driver is drowsy, the robot 100a may activate the self-driving function of the self-driving vehicle 100b or assist the control of the driving platform of the self-driving vehicle 100b. Here, the function of the self-driving vehicle 100b controlled by the robot 100b may include not only the self-driving function but also the navigation system installed inside the self-driving vehicle 100b or the function provided by the audio system of the self-driving vehicle 100b.

Also, the robot 100a interacting with the self-driving vehicle 100b may provide information to the self-driving vehicle 100b or assist functions of the self-driving vehicle 100b from the outside of the self-driving vehicle 100b. For example, the robot 100a may provide traffic information including traffic sign information to the self-driving vehicle 100b like a smart traffic light or may automatically connect an electric charger to the charging port by interacting with the self-driving vehicle 100b like an automatic electric charger of the electric vehicle.

<AI+Robot+XR>

By employing the AI technology, the robot 100a may be implemented as a guide robot, a transport robot, a cleaning robot, a wearable robot, an entertainment robot, a pet robot, or an unmanned flying robot.

The robot 100a employing the XR technology may correspond to a robot which acts as a control/interaction target in the XR image. In this case, the robot 100a may be distinguished from the XR device 100c, both of which may operate in conjunction with each other.

If the robot 100a, which acts as a control/interaction target in the XR image, obtains sensor information from the sensors including a camera, the robot 100a or XR device 100c may generate an XR image based on the sensor information, and the XR device 100c may output the generated XR image. And the robot 100a may operate based on the control signal received through the XR device 100c or based on the interaction with the user.

For example, the user may check the XR image corresponding to the viewpoint of the robot 100a associated remotely through an external device such as the XR device 100c, modify the navigation path of the robot 100a through interaction, control the operation or navigation, or check the information of nearby objects.

<AI+Self-Driving+XR>

By employing the AI and XR technologies, the self-driving vehicle 100b may be implemented as a mobile robot, an unmanned ground vehicle, or an unmanned aerial vehicle.

The self-driving vehicle 100b employing the XR technology may correspond to a self-driving vehicle having a means for providing XR images or a self-driving vehicle which acts as a control/interaction target in the XR image. In particular, the self-driving vehicle 100b which acts as a control/interaction target in the XR image may be distinguished from the XR device 100c, both of which may operate in conjunction with each other.

The self-driving vehicle 100b having a means for providing XR images may obtain sensor information from sensors including a camera and output XR images generated based on the sensor information obtained. For example, by displaying an XR image through HUD, the self-driving vehicle 100b may provide XR images corresponding to physical objects or image objects to the passenger.

At this time, if an XR object is output on the HUD, at least part of the XR object may be output so as to be overlapped with a physical object at which the passenger gazes. On the other hand, if an XR object is output on a display installed inside the self-driving vehicle 100b, at least part of the XR object may be output so as to be overlapped with an image object. For example, the self-driving vehicle 100b may output XR objects corresponding to the objects such as roads, other vehicles, traffic lights, traffic signs, bicycles, pedestrians, and buildings.

If the self-driving vehicle 100b, which acts as a control/interaction target in the XR image, obtains sensor information from the sensors including a camera, the self-driving vehicle 100b or the XR device 100c may generate an XR image based on the sensor information, and the XR device 100c may output the generated XR image. And the self-driving vehicle 100b may operate based on the control signal received through an external device such as the XR device 100c or based on the interaction with the user.

In this document, preferred embodiments of the present disclosure have been described, but the technical scope of the present disclosure is not limited only to the specific embodiments. Therefore, the present disclosure may be modified, changed, or updated in various ways within the technical principles and scope defined by the appended claims.

In the exemplary system described above, methods are described according to a flow diagram by using a series of steps and blocks. However, the present disclosure is not limited to a specific order of the steps, and some steps may be performed with different steps and in a different order from those described above or simultaneously. Also, it should be understood by those skilled in the art that the steps shown in the flow diagram are not exclusive, other steps may be further included, or one or more steps of the flow diagram may be deleted without influencing the technical scope of the present disclosure.

The appended claims of the present disclosure may be combined in various ways. For example, technical features of method claims of the present disclosure may be combined to be implemented as an apparatus, and technical features of apparatus claims of the present disclosure may be combined to be implemented as a method. Also, technical features of method claims and technical features of apparatus claims of the present disclosure may be combined to be implemented as an apparatus, and technical features of method claims and technical features of apparatus claims of the present disclosure may be combined to be implemented as a method.

1. A method for multi-access (MA) protocol data unit (PDU) session, the method performed by a user equipment (UE) and comprising:
receiving measurement assistance information from a session management function (SMF) node,
wherein the measurement assistance information relates to the MA PDU session over a 3rd generation partnership project (3GPP) access and non-3GPP access; and
transmitting a report, based on the measurement assistance information,
wherein the report includes information on an availability or unavailability of at least one access of the 3GPP access and the non-3GPP access, and
wherein the report is transmitted via a user plane to a user plane function (UPF) node.

2. The method of claim 1,
wherein the measurement assistance information is received in a PDU session establishment accept message.

3. The method of claim 1, further comprising:
detecting the availability or unavailability of at least one access of the 3GPP access and the non-3GPP access.

4. The method of claim 3,
wherein the detecting detects the availability or the unavailability based on one or more of information on the strength of a radio signal from one of the 3GPP access and the non-3GPP access and information received from a network; and
wherein the information received from the network includes service area restriction and restricted area information.

5. The method of claim 1, wherein the report is delivered from the UPF node to the SMF.

6. The method of claim 4, wherein the report is used for the SMF to perform a traffic steering.

7. The method of claim 1, further comprising:
transmitting a service request message over the non-3GPP access based on (i) that the report needs to be transmitted and (ii) that the UE is in an idle status over the non-3GPP access.

8. A method for a Multi-Access (MA) Protocol Data Unit (PDU) session by a Session Management Function (SMF) node, the method comprising:
transmitting measurement assistance information to a User Equipment (UE),
wherein the measurement assistance information is related to the MA PDU session over 3rd Generation Partnership Project (3GPP) access and non-3GPP access;
receiving a report on the UE from a User Plane Function (UPF) node,
wherein the report includes information on availability or unavailability of at least one access of the 3GPP access and the non-3GPP access in the MA PDU session; and
performing traffic steering for the MA PDU session based on the received report.

9. The method of claim 8,
wherein the measurement assistance information is transmitted by being included in a PDU Session Establishment Accept message.

10. The method of claim 8,
wherein the performing traffic steering moves a Guaranteed Bit Rate (GBR) QoS flow within the MA PDU session between the 3GPP access and the non-3GPP access.

11. The method of claim 8,
wherein the report is received when one of the 3GPP access and the non-3GPP access becomes available or unavailable.

12. A method for a Multi-Access (MA) Protocol Data Unit (PDU) session, the method performed by a Session Management Function (SMF) node and comprising:
transmitting a first message for requesting a reactivating a user plane resource over at least one access of a 3rd generation partnership project (3GPP) access and non-3GPP access, based on that the user plane resource over the at least one access is in an inactive state;
receiving a second message from an Access and Mobility Management Function (AMF) node; and
transmitting a third message including information that the UE is unreachable over the at least one access, based on that the second message is used to notify that the UE is unreachable over the at least one access.

13. The method of claim 12,
wherein the second message is used to represent an rejection of the reactivation, based on the non-3GPP access (i) where the user plane resource is in the inactive state and (ii) where the UE is unreachable.

14. The method of claim 12, further comprising:
before transmitting the first message, receiving, from a User Plane Function (UPF) node, a report notifying that the at least one access is unavailable.

15. The method of claim 12, further comprising:
transmitting measurement assistance information (MAI) to a User Equipment (UE).

16. (canceled)

17. An apparatus for a Multi-Access (MA) Protocol Data Unit (PDU) session, the apparatus comprising:
at least one processor; and
at least one memory capable of storing instructions and being connected electrically to the at least one processor operably,
wherein an operation, performed when the instructions are executed by the at least one processor, includes:
receiving measurement assistance information from a Session Management Function (SMF) node,
wherein the measurement assistance information is related to the MA PDU session over 3rd Generation Partnership Project (3GPP) access and non-3GPP access; and
transmitting a report, based on the measurement assistance information,
wherein the report includes information on availability or unavailability of at least one of the 3GPP access and the non-3GPP access, and
wherein the report is transmitted via a user plane to a User Plane Function (UPF) node.

18. The apparatus of claim 17,
wherein the measurement assistance information is received in a PDU Session Establishment Accept message.

19. (canceled)

20. A non-volatile computer-readable storage medium recording instructions,
wherein the instructions, when executed by one or more processors, instruct the one or more processors to perform:
receiving measurement assistance information from a Session Management Function (SMF) node,
wherein the measurement assistance information is related to the MA PDU session on 3rd Generation Partnership Project (3GPP) access and non-3GPP access; and
transmitting a report, based on the measurement assistance information,
wherein the report includes information on availability or unavailability of at least one of the 3GPP access and the non-3GPP access, and
wherein the report is transmitted via a user plane to a User Plane Function (UPF) node.

21. A Session Management Function (SMF) node for a Multi-Access (MA) Protocol Data Unit (PDU) session, the SMF node comprising:
at least one processor; and
at least one memory capable of storing instructions and being connected electrically to the at least one processor operably,
wherein an operation, performed when the instructions are executed by the at least one processor, includes:
transmitting measurement assistance information to a User Equipment (UE),
wherein the measurement assistance information is related to the MA PDU session over 3rd Generation Partnership Project (3GPP) access and non-3GPP access;
receiving a report on the UE from a User Plane Function (UPF) node,
wherein the report includes information on availability or unavailability of at least one of the 3GPP access and the non-3GPP access within the MA PDU session; and
performing traffic steering for the MA PDU session based on the received report.

22. The method of claim 21, wherein the operation further comprise:
transmitting a first message for requesting a reactivating a user plane resource over at least one access of a 3GPP access and non-3GPP access, based on that the user plane resource over the at least one access is in an inactive state;
receiving a second message from an Access and Mobility Management Function (AMF) node; and
transmitting a third message including information that the UE is unreachable over the at least one access, based on that the second message is used to notify that the UE is unreachable over the at least one access.

23. (canceled)
